(19) United States
(12) Patent Application Publication
(10) Pub. No.: US 2022/0309586 A1
(43) Pub. Date: Sep. 29, 2022

(54) Systems and Methods for Managing Investments

(71) Applicant: Jason M. Burke, Chestnut Hill, MA (US)

(72) Inventor: Jason M. Burke, Chestnut Hill, MA (US)

(21) Appl. No.: 17/705,240

(22) Filed: Mar. 25, 2022

Related U.S. Application Data
(60) Provisional application No. 63/165,787, filed on Mar. 25, 2021.

(51) Int. Cl. G06Q 40/06

(52) U.S. Cl. CPC G06Q 40/06

(57) ABSTRACT

The present disclosure provides systems and methods for managing investments. In some aspects, an investment management system comprising at least one processor configured to receive a selection from one or more users relating to interest from the one or more users in an investment opportunity, wherein interest is in the form of a vote, determine if an aggregate of the selections from the one or more users relating to the interest in the investment opportunity reaches a threshold amount of interest, present, if the threshold amount of interest has been met, information relating to the investment opportunity, and receive a selection from the one or more users relating to a financial commitment from the one or more users in the investment opportunity.

### RELATED APPLICATIONS

This application claims the benefit of and priority to U.S. Provisional Application No. 63/165,787 filed Mar. 25, 2021, and the contents of this application is hereby incorporated herein by reference its entirety.

### FIELD

The present disclosure relates to systems and methods for managing the investment activity for one or more groups of investors.

### BACKGROUND

It is becoming more common for individuals to seek out various types of investment opportunities, such as investing in small and early-stage companies. It can become important, as investment groups become more popular and more companies are looking to these groups for investments, for investment groups to have organized ways to manage and track their investments and new opportunities to invest.

SUMMARY

The present disclosure is directed to systems and methods for managing investments. In some embodiments, a method for managing investments can include receiving, on at least one processor, information relating to an investment such that one or more users, which can include investors, investor groups or founders, can view the investment information. The one or more users can make decisions relating to their investment interest. The method can further include receiving, from at least one processor, information from one or more users relating to investment interest.

In some aspects, the present disclosure provides a system for managing investments comprising at least one processor configured to receive a selection from one or more users relating to interest from the one or more users in an investment opportunity, wherein interest is in the form of a vote, determine if an aggregate of the selections from the one or more users relating to the interest in the investment opportunity reaches a threshold amount of interest, present, if the threshold amount of interest has been met, information relating to the investment opportunity, and receive a selection from the one or more users relating to a financial commitment from the one or more users in the investment opportunity.

In some embodiments, the at least one processor is configured to store a status of the investment opportunity, and the status of the investment opportunity is dynamically updated by the processor if the threshold amount of financial commitment is met. In some embodiments, the at least one processor is configured to store a status of the investment opportunity, and the status of the investment opportunity is dynamically updated by the processor if the threshold amount of interest is met. In some embodiments, the at least one processor is configured to store a status of the investment opportunity, the status of the investment opportunity including a deal screening stage in which the one or more users make selections regarding interest in the deal and a deal finance stage in which the threshold amount of money is met.

In some embodiments, the at least one processor is further configured to communicate with an external financial platform, information relating to a total of the financial commitments from each user and a list of users associated with the financial commitments. In some embodiments, the at least one processor is further configured to display interest in an investment opportunity including at least one of a list of users having indicated a certain level of interest in the investment opportunity and metrics associated with the interest in the investment opportunity.

A method for managing investments can be provided that comprises receiving, by at least one processor, a selection from one or more users relating to interest from the one or more users in an investment opportunity, wherein interest is in the form of a vote, determining, by the at least one processor, if an aggregate of the selections from the one or more users relating to the interest in the investment opportunity reaches a threshold amount of interest, presenting, by at least one processor, if the threshold amount of interest has been met, information relating to the investment opportunity, and receiving, by at least one processor, a selection from the one or more users relating to a financial commitment from the one or more users in the investment opportunity.

In some embodiments, the method can further comprise determining, by the at least one processor, if an aggregate of the selections from the one or more users relating to the financial commitments in the investment opportunity reaches a threshold amount of money.

In some embodiments, a status of the investment opportunity is updated if the threshold amount of financial commitment is met. In some embodiments, a status of the investment opportunity is updated if the threshold amount of interest is met. In some embodiments, the status of the deal includes a deal screening stage in which the one or more users make selections regarding interest in the deal and a deal finance stage in which the threshold amount of money is met.

In some embodiments, the method can further comprise communicating, by the at least one processor, to an external financial platform, information relating to a total of the financial commitments from each user and a list of users associated with the financial commitments. In some embodiments, the method can further comprise displaying, by the least one processor, interest in an investment opportunity including at least one of a list of users having indicated a certain level of interest in the investment opportunity and metrics associated with the interest in the investment opportunity.

A method for managing investments can be provided that comprises presenting, by at least one processor, information relating to an investment opportunity to one or more users, receiving, by at least one processor, a selection from the one or more users relating to a financial commitment from the one or more users in the investment opportunity, determining, by the at least one processor, if an aggregate of the selections from the one or more users relating to the financial commitment in the investment opportunity reaches a threshold amount of money, and updating, by at least one processor, if the threshold amount of financial commitment has been met, a status of the investment opportunity to indicate that the investment opportunity is funded.

In some embodiments, the method can further comprise receiving, by at least one processor, a selection from one or more of the users relating to interest from the one or more users in the investment opportunity. In some embodiments, the method can further comprise communicating, by the at least one processor, to an external financial platform, information relating to a total of the financial commitments from each user and a list of users associated with the financial commitments.

### BRIEF DESCRIPTION OF THE DRAWINGS

The present disclosure is further described in the detailed description which follows, in reference to the noted plurality of drawings by way of non-limiting exemplary embodiments, in which like reference numerals represent similar parts throughout the several views of the drawings, and wherein:

FIG. 1A shows an exemplary schematic flow diagram of an embodiment of an investment management system;

FIG. 1B depicts an exemplary embodiment of the investment management system;

FIG. 2 illustrates an exemplary embodiment of an exemplary user interface relating to deal creation;

FIG. 3 illustrates an exemplary embodiment of a user interface relating to deal updating;

FIGS. 4A and 4B illustrate exemplary embodiments of a user interface that enables a user to managing collateral/documentation associated with an exemplary deal;

FIG. 5 illustrates an exemplary embodiment of a user interface displaying various deal documents available for editing and/or deletion from the system;

FIGS. 6A and 6B illustrate exemplary embodiments of a user interface including functionality to allow a user to log interest in a particular deal with the investment management system;

FIG. 7A, FIG. 7B, FIG. 8A, and FIG. 8B illustrate exemplary embodiments of a user interface including functionality to allow for managing commitments to invest in deals;

FIG. 9, FIG. 10, and FIG. 11 illustrate exemplary embodiments of a user interface including functionality to manage questions to deal company founders;

FIG. 12A and FIG. 12B illustrate exemplary embodiments of a user interface including functionality to update the status of a deal;

FIG. 13 illustrates exemplary embodiments of a user interface including functionality to associate investment activity with a deal;

FIG. 14 illustrates exemplary embodiments of a user interface including functionality to submit feedback for a deal;

FIG. 15 illustrates exemplary embodiments of a user interface including functionality to review change history for a deal;

FIG. 16 illustrates an exemplary embodiment of a user interface with information about the interest declared for a deal can be available for review by users;

FIG. 17 illustrates an exemplary embodiment of a user interface with the calculation of estimated fees associated with the commitments may be rendered for review by investment management system users;

FIGS. 18A and 18B illustrate exemplary embodiments of a user interface with information about the commitments declared for deal may be available for review by users;

FIG. 19 illustrates an exemplary embodiment of a user interface for the provisioning of access to a deal to the relevant founder for purposes of founder deal management;

FIG. 20 illustrates an exemplary embodiment of a user interface for reviewing deals across a set of statuses;

FIGS. 21A and 21B illustrate exemplary embodiments of a user interface listing the investments made on a deal;

FIGS. 22A and 22B illustrate exemplary embodiments of a user interface with lists of the deals available to the particular system user;

FIG. 23A, FIG. 23B, FIG. 24A, and FIG. 24B illustrate exemplary embodiments of a user interface including a portfolio of deals which may include performance metrics and other descriptive attributes;

FIG. 25 illustrates an exemplary embodiment of a user interface including investment growth statistics over a period of time

FIG. 26 illustrates an exemplary user interface of a graph showing deals and investments in the investment management system over time;

FIG. 27 illustrates an exemplary user interface of a graph showing information about the number of deals created in the investment management system over time;

FIG. 28 illustrates an exemplary user interface of a graph including metrics related to the investment activity levels by investors within the investment group;

FIG. 29 illustrates an exemplary user interface showing a graph of an investment group size over time;

FIGS. 30A and 30B illustrate exemplary embodiments of a user interface related to deal details available for reviewing interest levels in a deal, reviewing feedback for a deal, reviewing planned investment sum in a deal and, reviewing investment activity in a deal;

FIGS. 31A and 31B illustrate exemplary embodiments of a user interface related to reviewing the investors within an investment group who have experience in the same sectors as the deal company;

FIGS. 32A and 32B illustrate exemplary embodiments of a user interface related to deal sharing;

FIG. 33 illustrates an exemplary embodiment of a user interface related to an invited party;

FIG. 34 illustrates an exemplary embodiment of a user interface that can allow for certain data to be suppressed from display to system users;

FIG. 35 illustrates an exemplary embodiment of a user interface for investor registration;

FIGS. 36 and 37 illustrate exemplary embodiments of a user interface related to system management by a group administrator;

FIG. 38 depicts an exemplary computing device;

FIG. 39 depicts a block diagram of an exemplary computer-based system and platform 800 in accordance with one or more embodiments of the present disclosure;

FIG. 40 depicts a block diagram of an exemplary computer-based system and platform in accordance with one or more embodiments of the present disclosure; and

FIGS. 41 and 42 illustrate schematics of exemplary implementations of the cloud computing/architecture(s).

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It will be understood that various changes may be made in the function and arrangement of elements without departing from the spirit and scope of the presently disclosed embodiments.

Specific details are given in the following description to provide a thorough understanding of the embodiments. However, it will be understood by one of ordinary skill in the art that the embodiments may be practiced without these specific details. For example, systems, processes, and other elements in the presently disclosed embodiments may be shown as components in block diagram form in order not to obscure the embodiments in unnecessary detail. In other instances, well-known processes, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Subject matter will now be described more fully with reference to the accompanying drawings, which form a part hereof, and which show, by way of illustration, specific example aspects and embodiments of the present disclosure. Subject matter may, however, be embodied in a variety of different forms and, therefore, covered or claimed subject matter is intended to be construed as not being limited to any example embodiments set forth herein; example embodiments are provided merely to be illustrative. The following detailed description is, therefore, not intended to be taken in a limiting sense.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” means that events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc. As used herein, the terms “dynamically” and automatically are used interchangeably and have the same meaning.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

In another form, a non-transitory article, such as a non-transitory computer readable medium, may be used with any of the examples mentioned herein or other examples except that it does not include a transitory signal per se. It does include those elements other than a signal per se that may hold data temporarily in a “transitory” fashion such as RAM and so forth.

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multicore, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budgets, input data rates, output data rates, memory resources, data bus speeds and other design or performance constraints.

The present disclosure relates to systems and methods for managing investments, such as investment opportunities (“deals”) by one or more investors and/or groups of investors (investment groups or investor groups). In some embodiments, the investment management system can allow one or more of system users, including individual investors, one or more investment groups, and/or one or more company founders (“founder”), to manage one or more deals in an investment management system. In some embodiments, the investment management system can be configured to manage all or any subset of the different phases or stages of an investment opportunity, including but not limited to deal creation, deal screening, and/or deal commitment. Deal creation involves a new investment opportunity being created in the investment management system. Deal creation can be performed by any user of the system, including the founder of the company associated with the new deal or a system user designated as an investment administration. Deal screening involves collecting information from system users, such as investors and/or investor groups regarding interest in the investment opportunities that have been entered into the investment management system. Deal commitment involves a commitment of funds from one or more investors and/or investor groups to fund a deal.

The investment management system can also include functionality to allow for analytics related to the deals, deal commitments, deal screening, and investor and/or investor group activity in the investment management system. In some embodiments, the investment management system can allow Investors and/or Investment Groups and/or Founders to analyze deals (“Deal Analytics”). In some embodiments, the investment management system can allow Investors to analyze activity for an Investor (“Investor Analytics”). In some embodiments, the investment management system can allow Investors and/or Founders to analyze activity for an Investment Group (“Investment Group Analytics”).

In some embodiments, the investment management system can allow Investors and/or Investment Group administrators (“Group Administrators”) and/or Founders and/or system administrators (“System Administrators”) to manage system access for other Investors and/or Investment Groups and/or Founders. In some embodiments, the investment management system can allow Group Administrators to manage system access for an Investment Group, to engage with other Investment Groups. In some embodiments, the investment management system can allow Group Administrators to configure investment management system features and privacy settings for an Investment Group. In some embodiments, the investment management system can allow for the recommendation of deals (“Deal Recommendation”) to Investors and Investment Groups. In some embodiments, the investment management system can allow for the recommendation of Investors and Investment Groups (“Investor Recommendation”) to Investors. In some embodiments, the investment management system can allow for the recommendation of Investors and Investment Groups to Founders.

The investment management system is also capable of allowing users to give access to the system as it relates to specific deals to one or more temporary users. In some embodiments, the investment management system can allow for investors and founders to invite Investors or Investment groups to invest in a deal (“Deal Sharing”). In some embodiments, the investment management system can allow for users to analyze deal sharing (“Deal Sharing Analytics”). In some embodiments, the investment management system can allow for Investors to follow other investors (“Investor Following”). In some embodiments, the investment management system can allow for investors and investment groups to follow founders (“Founder Following”). In some embodiments, the investment management system can integrate with external systems (“External Systems”) for purposes of enabling functionality and services provided by those External Systems.

Each system user, including each investor, investor group, group administrator, and founder, is given access to the investment management system with a unique login that is associated with that user, and optionally one or more investment groups that the user is a member of. The system can also include functionality, for example using exemplary specialized graphical user interfaces, such that a particular user can set up personalized parameters for their instantiation of the system when they have logged in thereto such that those personalized parameters are used to generate the user interfaces when they utilize the investment management system. These personalized parameters can include, but are not limited to, settings relating to personal information that is visible to other system users. Similarly, one or more system users can be designated as administrators and the system can include functionality, for example using exemplary specialized graphical user interfaces, such that the administrator user can set up parameters for an investment group's instantiation of the system such that those parameters are used to generate the user interfaces of members of each investment group when they utilize the investment management system. This allows for customization of any of the system features described herein on an investment group level, such that any system feature can be turned on or off for each investment group. The graphical user interfaces generated on the processor of each user is thus customized based on parameters set by the user and/or an administrator that are stored in one or more databases at a remote location, such as a cloud database or a database stored on a central processor.

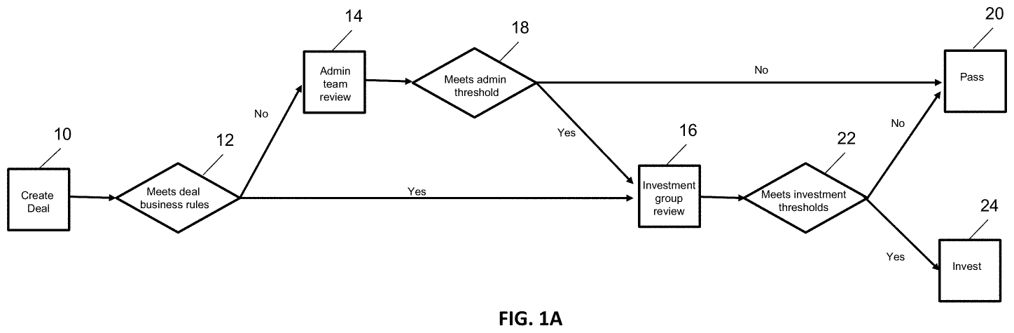

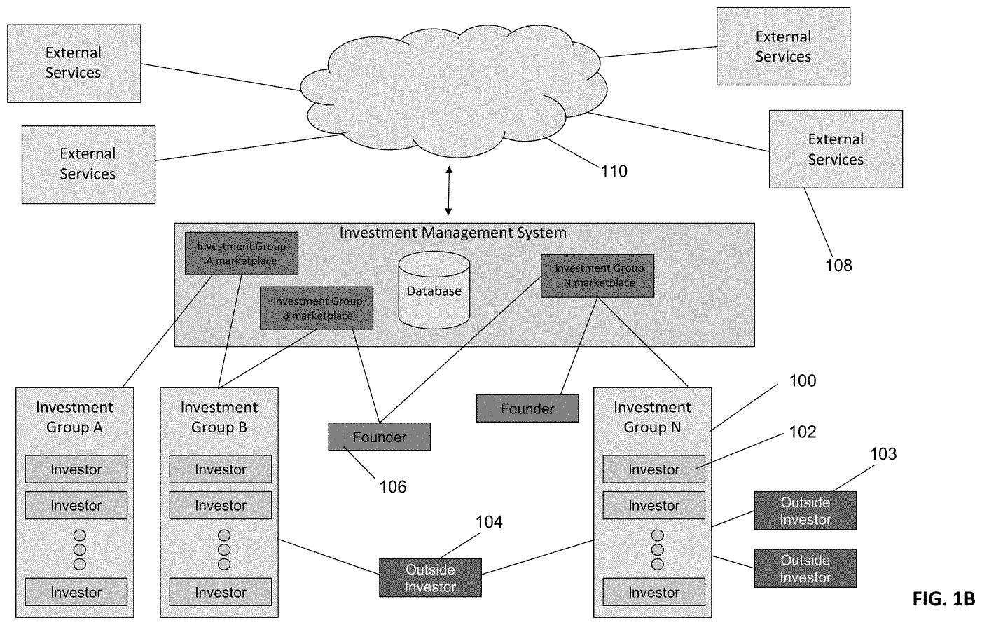

FIG. 1A depicts an exemplary flow chart of an embodiment of a workflow associated with an exemplary session with an investment management system. In some embodiments, a user may initiate an electronic communication or exchange session on an electronic execution-mediating cloud platform to initiate communication amongst parties using the investment management system. As shown in FIG. 1A, in step 10, a deal may be created within the investment management system through a graphical user interface or an API. The deal may move through one or more system reviews to compare attributes, or actions taken on the deal to determine the status and handling of the deal. In step 12, the system can compare information entered into the system regarding the deal with a set of business rules to determine whether or not the deal must them proceed to a review by one or more administrator users of the system (step 14) or the deal can proceed directly to review by one or more users of the system (step 16). The system will compare the various deal declarations against the business rules configured for the investment group's instance of the investment management system and adjust the status of the deal as appropriate. During administrator review of the deal (step 14), if the deal does not meet a threshold (step 18), the deal is passed on (step 20) and the system does not display this deal to the users. If the deal meets the threshold, the deal moves on to be presented to the system users for review (step 16). Depending on the status of the deal, it may be presented to users of the platform who can provide an indication of interest, and/or to provide a monetary commitment to invest in the deal. If investment thresholds are met (step 22), then the deal status can be updated to indicate that an investment will be made (step 24), for example, that the deal is funded.

FIG. 1B depicts an exemplary embodiment of the investment management system and shows a plurality of instances of investor groups using the system and the interfaces with users and external systems. As shown in FIG. 1B, an investment group 100 may be using a dedicated instance within the investment management system. The investment group may have one or more investors 102. The investment group may optionally have one or more outside investors 103, 104 associated with the group. One or more outside investors 104 may be associated with one or more investment groups. One or more founders 106 may be associated with one or more investment groups' instances of the investment management system. The investment management system may interface with one or more external services 108 through internet-based connections 110.

Deal Management

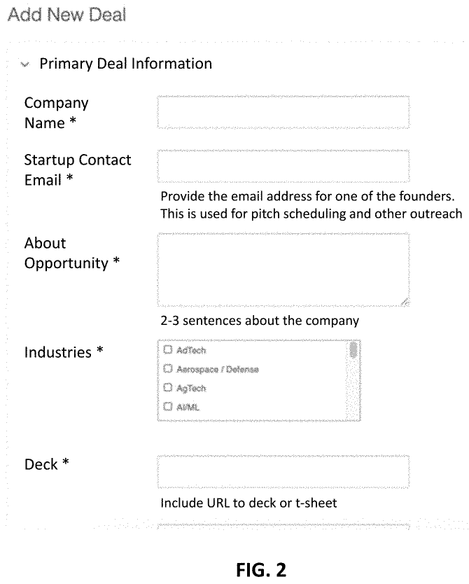

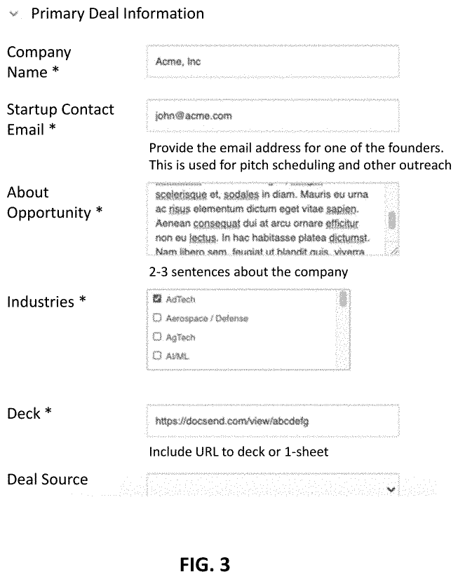

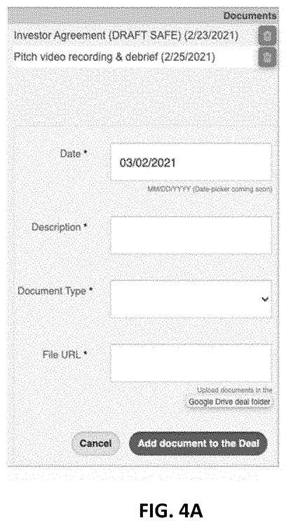

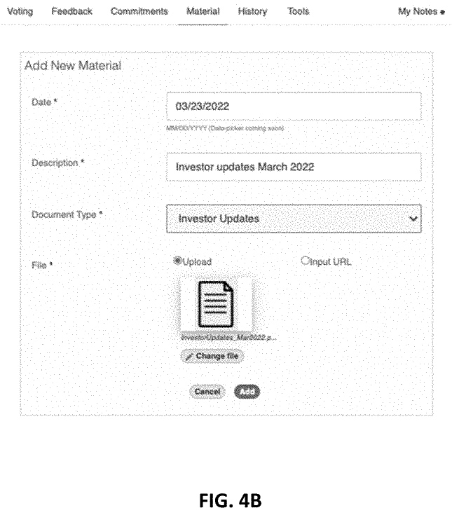

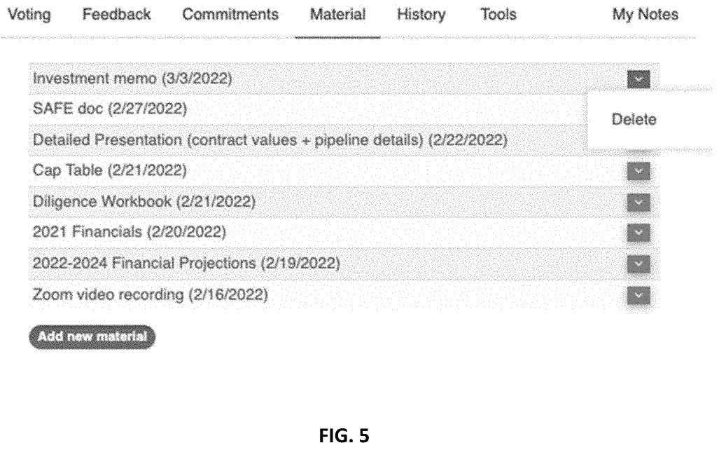

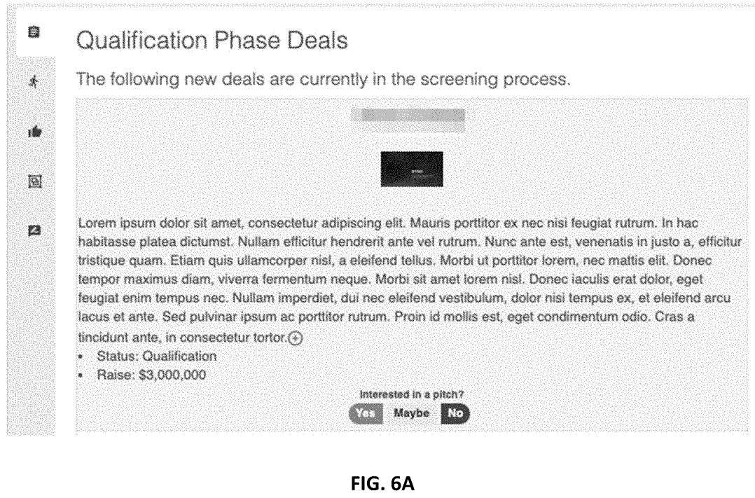

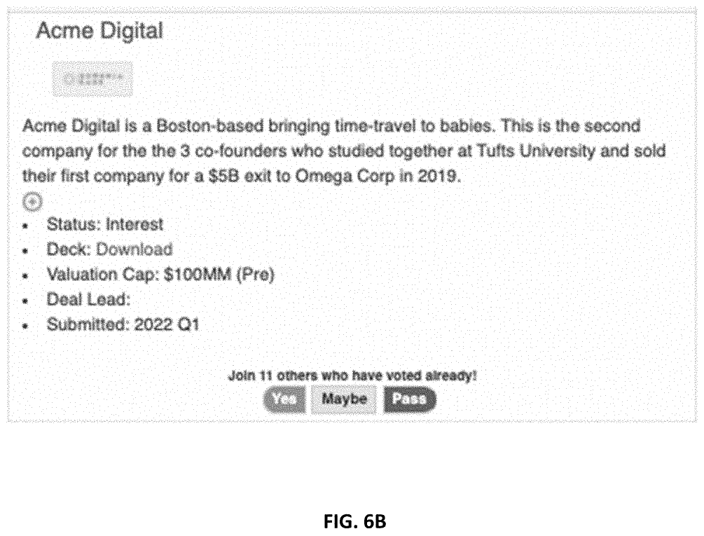

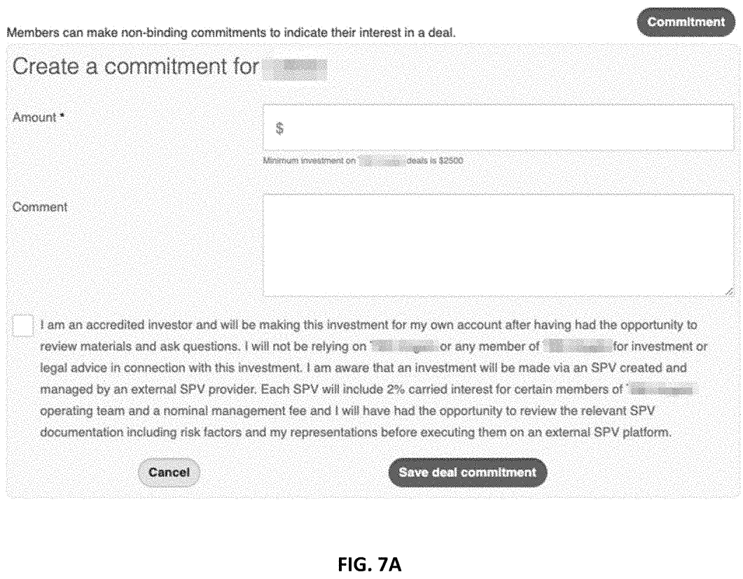

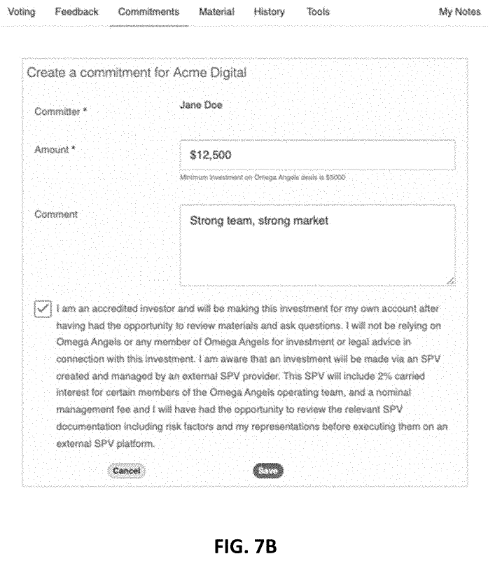

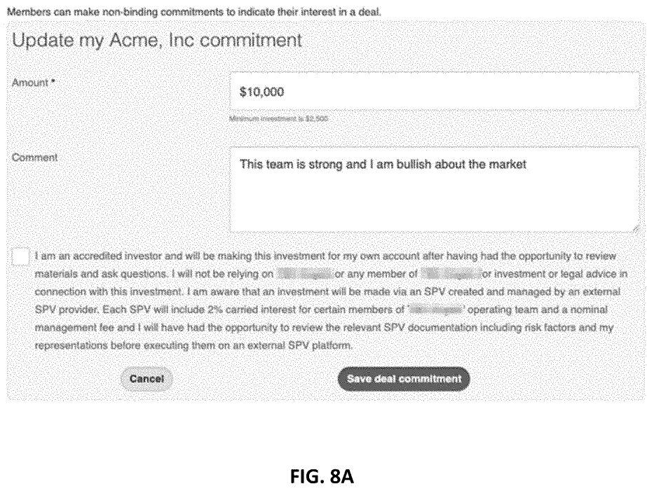

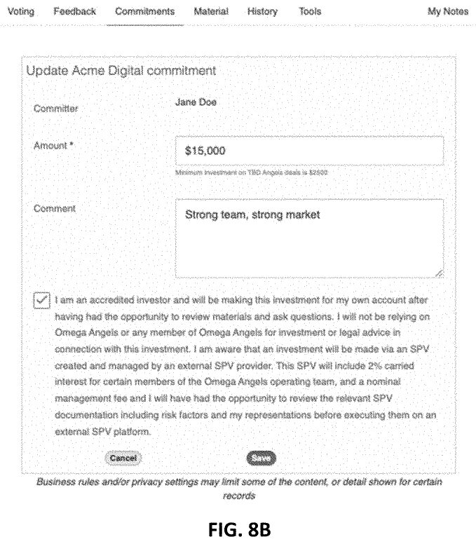

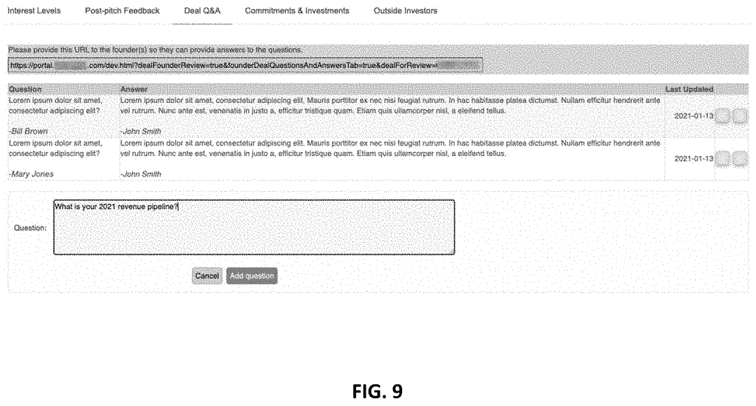

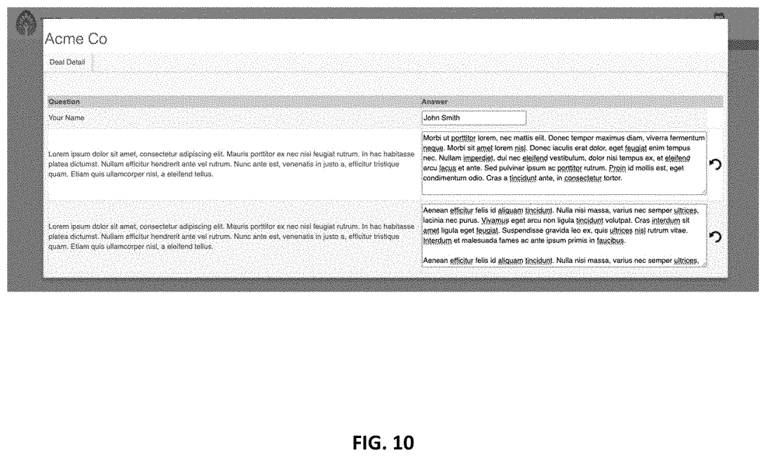

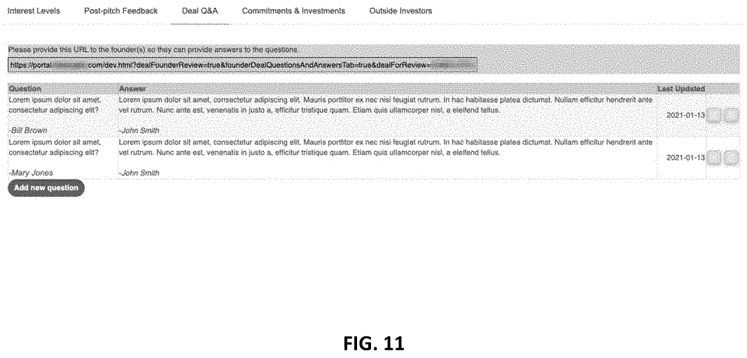

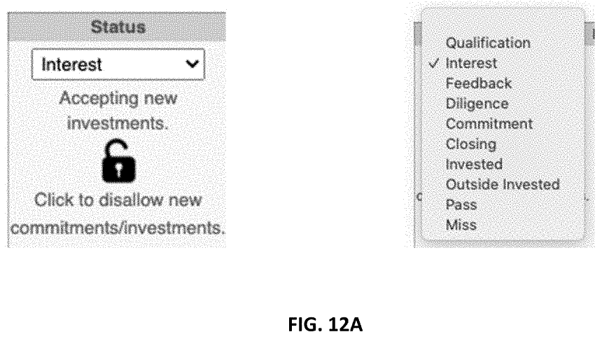

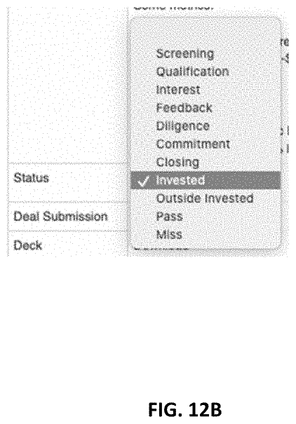

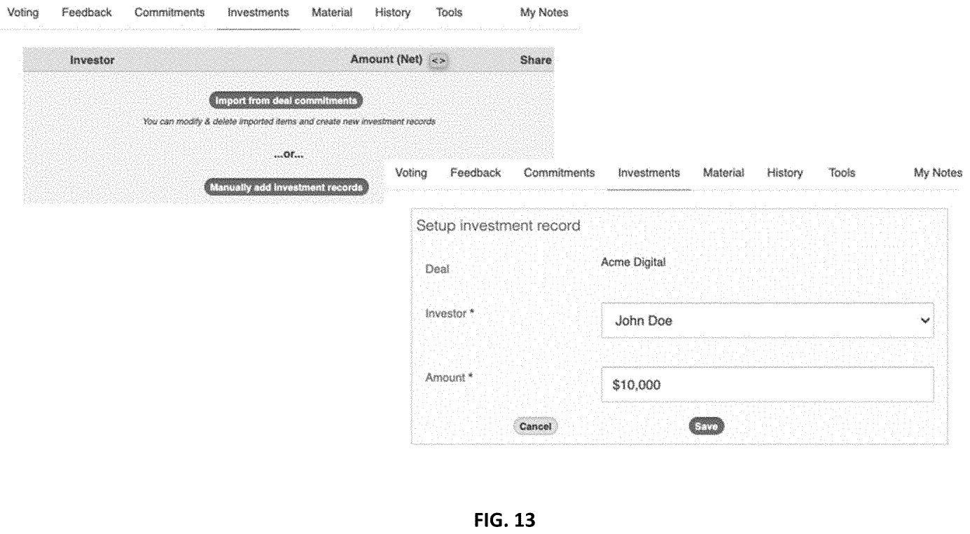

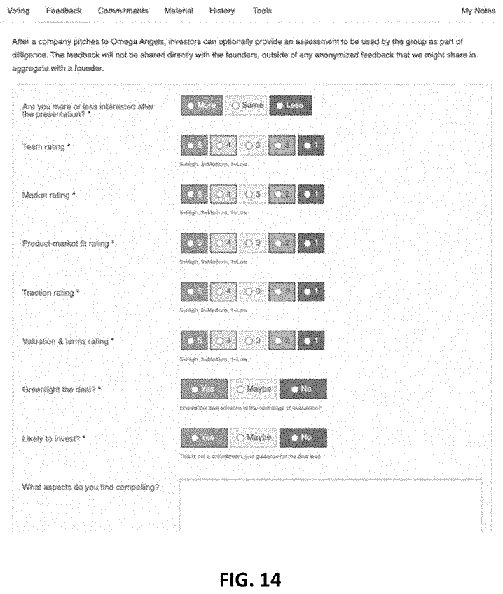

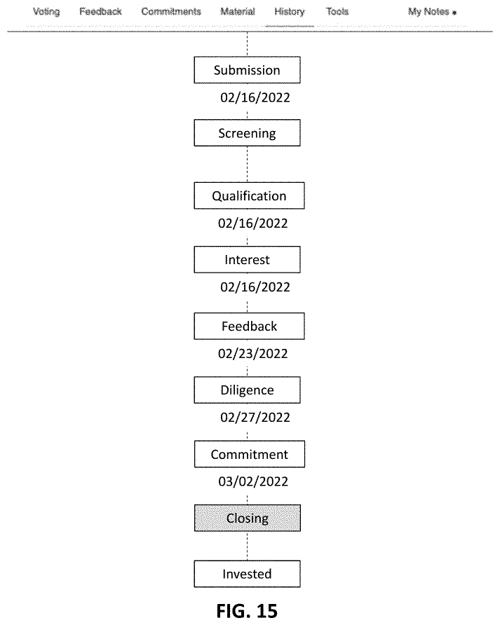

In some embodiments, the management of a deal in the investment management system can include but is not limited to creating information about deals and updating information about deals. In some embodiments, a deal update can include setting and changing of additional deal attributes (e.g., exemplary user interfaces shown in FIG. 2 and FIG. 3). In some embodiments, the investment management system allows for managing collateral/documentation associated with deals (e.g., exemplary user interfaces shown in FIG. 4A, FIG. 4B, and FIG. 5), declaring level of interest in deals (e.g., exemplary user interfaces shown in FIG. 6A and FIG. 6B), managing commitments to invest in deals (e.g., exemplary user interface shown in FIG. 7A, FIG. 7B, FIG. 8A, and FIG. 8B), managing questions to deal company founders (e.g., exemplary user interfaces shown in FIG. 9, FIG. 10, and FIG. 11), updating the status of a deal (e.g., exemplary user interfaces shown in FIG. 12A and FIG. 12B), associating investment activity with a deal (e.g., an exemplary user interface shown in FIG. 13), submitting feedback for a deal (e.g., an exemplary user interface shown in FIG. 14), reviewing change history for a deal (e.g., an exemplary user interface shown in FIG. 15), sharing a deal with investors, sharing a deal with founders.

FIG. 2 illustrates an exemplary embodiment of an exemplary user interface relating to deal creation. The investment management system is configured, via one or more graphical user interfaces, to allow a user to enter information to create an investment opportunity, or deal, within the system. Various types of information can be included during the deal create process or added to deal information after the deal has been create that relates to information about the deal and/or information about the company and/or founder associated with the deal, and can include but is not limited to the name of the company, one or more industries in which the company operates, various forms of company founder contact information, various forms of company founder demographic information, various investment-specific attributes (i.e., discount, valuation cap, current valuation) and company performance to date. In some embodiments, after deal information is added to the system, this information can be accessible to other system users, such as investors and/or investor groups and/or founders, for review and/or update and/or to apply other system functionality. The system allows for flexibility in providing access to individual users, subsets of user, or all system users to deal information.

Updating a deal in the investment management system allows for the editing of various information about the deal, including but not limited to name of the company, the industries in which the company operates, company founder contact information, investment-specific attributes (i.e., discount, valuation cap, and/or current valuation) and company performance to date. Editing features of the system can be configured such that the ability to edit and/or delete deal information can be limited to a certain system user or a subset of users. For example, in some embodiments, only the user that created the deal can update deal information. For example, in some embodiments, a subset of users can update deal information, such as a founder associated with the company related to the deal and designated investors associated with that founder. It will be understood that the system is fully configurable to allow for control and flexibility in entering, updating, and/or editing any information entered into the investment management system. FIG. 5 illustrates an exemplary embodiment of a user interface displaying various deal documents available for editing and/or deletion from the system. In some embodiments, uploaded documents and/or fields available to configure on the deal may vary and can depend on details of the deal and/or can be configured by certain system users.

The investment management system can allow for the upload and organization of documents/files for each deal created therein. The management of files associated with a deal within the investment management system allows for uploading of files (i.e., videos, documents, photos, audio) or linking to such files stored outside of the system. These files can include any data associated with a deal, including but not limited to company updates, company pitch material, company pitch videos, investment documentation. FIG. 4A and FIG. 4B illustrate exemplary embodiments of a user interface that enables a user to managing collateral/documentation associated with a deal, for example, by uploading documents/files into the system such that those uploaded documents/files are associated with a specific deal therein. The user can also update or delete these associations through the investment management system. FIG. 3 illustrates an exemplary embodiment of a user interface that enables a user to update or delete any document/file uploaded into the system. As explained above, it will be understood that the system is fully configurable to allow for control and flexibility in which users can update or delete documents/files. In some embodiments, the types of collateral that can be associated with a deal may vary and the collateral may be accessible to other system users based on certain system access rights.

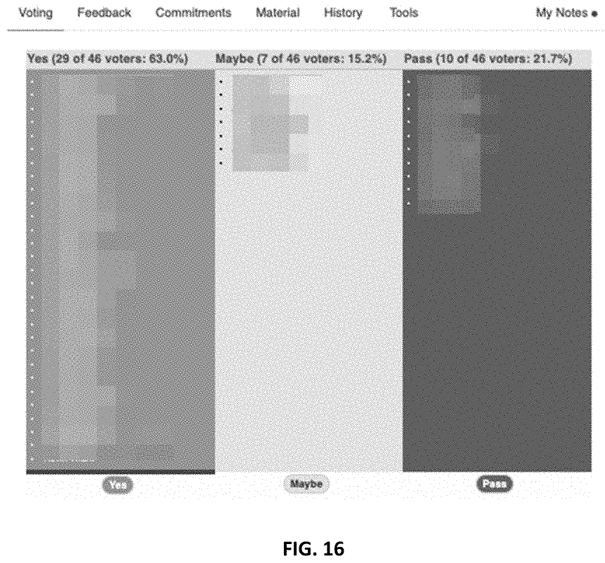

The investment management system provides various functionality to allow system users, such as investors or founders, to interact with a deal. In some embodiments, the investment management system includes functionality to allow a user to declare interest in a deal within the investment management system through a voting mechanism. FIG. 6A and FIG. 6B illustrate exemplary embodiments of a user interface including functionality to allow a user to log interest in a particular deal with the investment management system. As shown, a deal is shown as being in a screening phase such that the system can log investor interest in the deal. The user interface can display various information to the user, such as basic information about the company associated with the deal and the amount of money being raised. The investment management system is configured, via the graphical user interface, to allow the user to electronically select their interest in a specific deal. The interface includes one or more interactive features, such as a button, to allow a user to log interest in that deal (i.e., vote) such that the deal can proceed to a pitch phase wherein the company/founder associated with that deal can be invited to further interact with the investment management system and the potential users/investors (for example, those that voted to express interest in the pitch, or all the users of the system). In some embodiments, information about the interest declared for a deal can be available for review by users, as shown in the exemplary embodiment of a user interface for reviewing deal interest as shown in FIG. 16.

In some embodiments, declaring interest in a deal can be used to determine overall interest by the users of the system in order to continue engagement with the deal. For example, if a threshold amount of interest is determined by the system based on information from a voting mechanism, the system can be configured to keep the deal active such that the user that expressed interest, or all the system users, can interact with the company associated with the deal and gather additional information before monetary commitments are made by the users.

In some embodiments, declaring interest in a deal can be associated with an investment commitment such that the user can also communicate an amount for investment. The investment management system is configured, via a graphical user interface, to allow the user to electronically enter their financial commitment to a specific deal. The interface includes one or more interactive features to allow a user to log a monetary amount using a voting mechanism. Declaring financial commitments to a deal can be used by the system to update a status of the deal to an investment phase such that the financial commitment of the users is large enough for the investment in the deal is be completed. For example, if a threshold amount of money is committed by the users of the system based on information from a voting mechanism, the system can be configured to update the status of the deal.

It will be understood that the voting relating to deal interest can be optional. For example, in some embodiments, after deal creation, the system can include a first stage of voting that utilizes a voting mechanism to express interest in a deal, and then if a threshold amount of interest is reach, a second stage of voting can take place relating to financial commitment from one or more users. In some embodiments, after deal creation, the voting mechanism can be used in a single stage of voting as it relates to financial commitment.

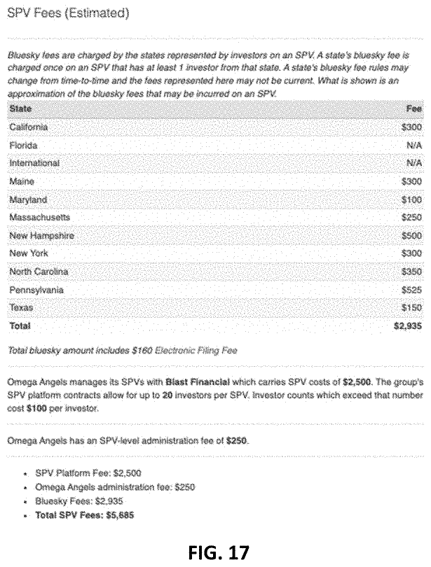

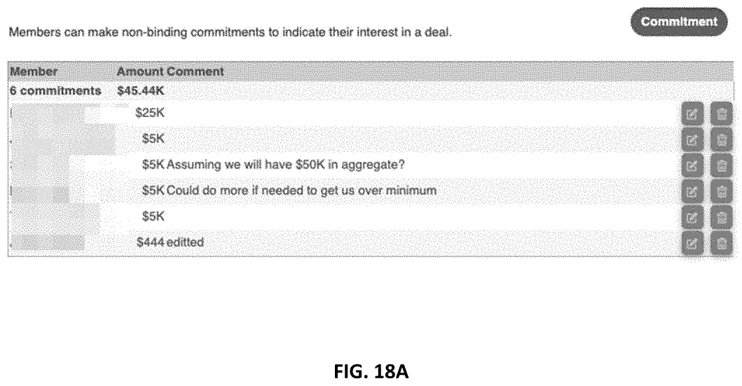

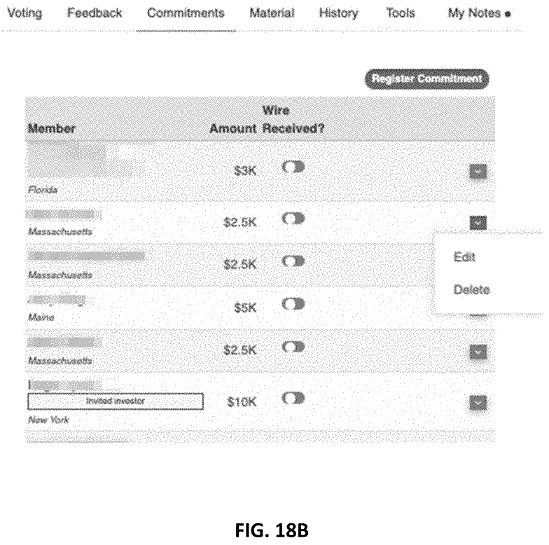

The investment management system is configured to allow for the declaration of commitments to invest in a deal, comments about the commitment and/or a declaration of investor accreditation (e.g., exemplary user interfaces shown in FIG. 7A and FIG. 7B) within the investment management system. In certain embodiments, commitments can be updated (e.g., exemplary user interfaces shown in FIG. 8A and FIG. 8B) and/or deleted. In some embodiments, the calculation of estimated fees associated with the commitments may be rendered for investment management system users (e.g., an exemplary user interface shown in FIG. 17). In certain embodiments, information about the commitments declared for deal may be available for review by users (e.g., exemplary user interfaces shown in FIG. 18A and FIG. 18B). In some embodiments, certain attributes of deals may be dynamically updated by the investment management system upon commitments declared by investors.

In some embodiments, certain attributes of deals can be dynamically updated by the investment management system upon actions taken with the voting mechanism. In some embodiments, the system can include an investment threshold such that the system can be configured to take one or more actions based on the investment threshold being met. The investment threshold can take various forms, such as a minimum number of users entering a positive vote into the system to indicate interest of those users in participating in an investment for that deal, or a minimum amount of money being committed to for an investment in the deal from one or more users of the system. Once the investment threshold has been met, the system can take one or more actions in response, including but not limited to updating a status of the deal, sending notification to users that have entered a positive vote, and/or notifying all system users of information relating to that deal. For example, a deal which secures a certain number of positive votes that correlate to investment commitments for a given deal can cause the system to update the status of the deal in real-time and may trigger real-time notifications to investors within the investment management system.

It can also be possible for the investment management system to be integrated with external system for the collection of the investments/financial commitments as committed to by the users/investors based on the results collected by the voting mechanism. In some embodiments, wiring status for an investment associated with monetary commitments can be managed by certain users. For example, a deal lead associated with the deal or one or more administrative users may denote a deal commitment for an investor as having been funded within an external platform. The integration between the investment management system and an external system may comprise of one or more Application Programming Interfaces (API), file protocols, emails, etc. An integration between the investment management system and an external system may allow for data and/or instruction to be delivered from one system to another.

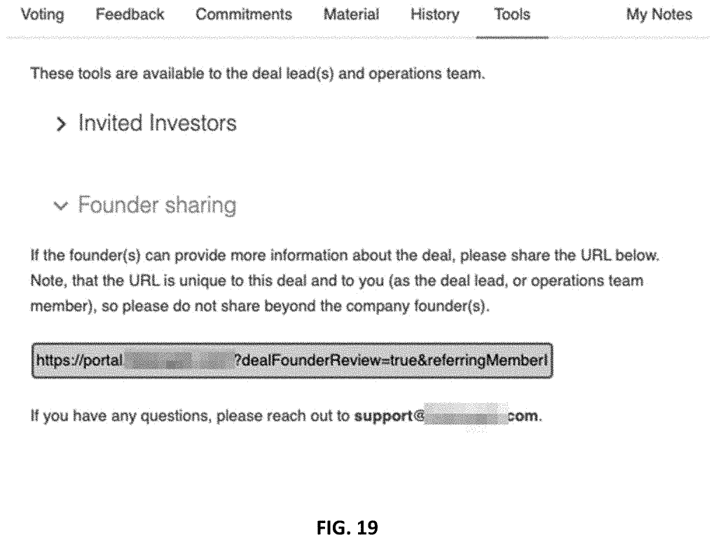

The investment management system allows for the provisioning of access to a deal to the relevant founder for purposes of founder deal management (e.g., an exemplary user interface shown in FIG. 19), including actions such as updating deal details, uploading deal material such as documents/files, submitting company founder demographics, and provisioning access to other company team members. Thus, the investment management system can be used by founders of a company associated with a deal in the system to manage all documentation and/or communicate with the users/investors to facilitate deal management.

The investment management system is configured to allow for interaction between system users, including investors, investor groups, and founders, to allow for communication therebetween at all levels and phases of the investment process. The investment management system allows for the submission of questions about the deal (e.g., an exemplary user interface shown in FIG. 9), which are made available for editing and review by other users. In some embodiments, questions are available for review and answering by founders (e.g., an exemplary user interface shown in FIG. 10).

The investment management system allows for the configuration of deal status (e.g., FIG. exemplary user interfaces shown in FIG. 12A and FIG. 12B) and the review of deals across a set of statuses (e.g., an exemplary user interface shown in FIG. 20) can be performed within the investment management system. For example, as shown in the exemplary user interfaces shown in FIG. 12A and FIG. 12B, a user designated as an administrator for a particular deal can be presented with an interface to set the status of deal such that the system can accept monetary commitments to invest in the deal. The user interface can also be used to indicate that a particular deal is closed such that commitments are no longer being accepted.

The investment management system allows various system users to provide content to be stored with or to be accessible to any subset of system user as designated by the users that provided the content. In some embodiments, investors can add self-provided content, such as text, images, and/or files to a particular deal, where that content is available to only that investor and to administrative users associated with the deal. In some embodiments, the investment management system allows founders to add self-provided content, such as text, images, files to a particular deal, where that content is available to only that Founder, and to Group Administrative users.

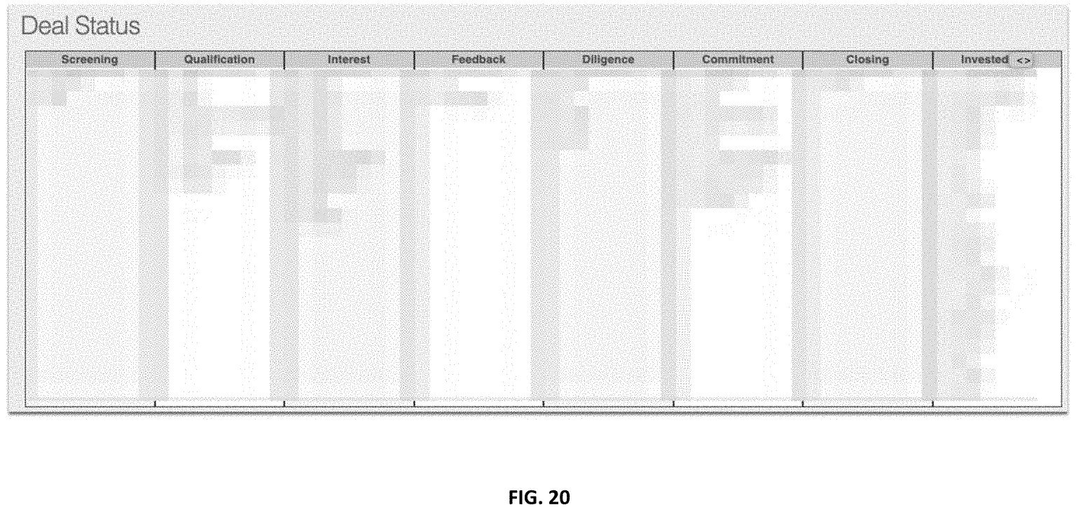

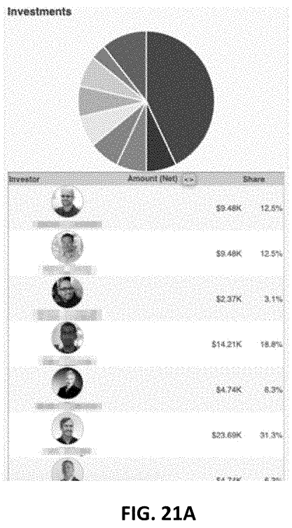

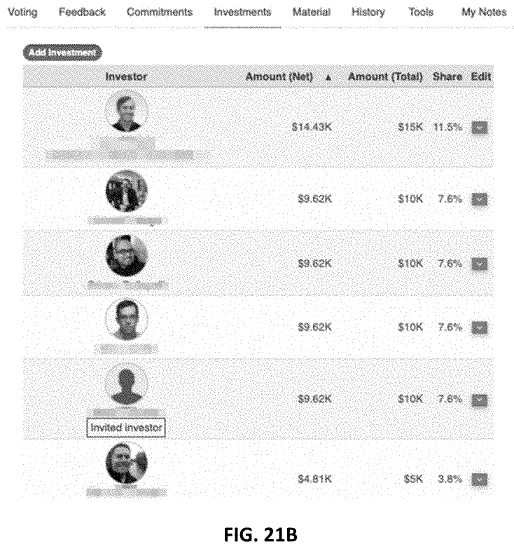

In some embodiments, the investment management system lists the investments made on a deal (e.g., exemplary user interfaces shown in FIG. 21A and FIG. 21B) where the embodiment for deal investment information may have limited information viewable, or editable by the user.

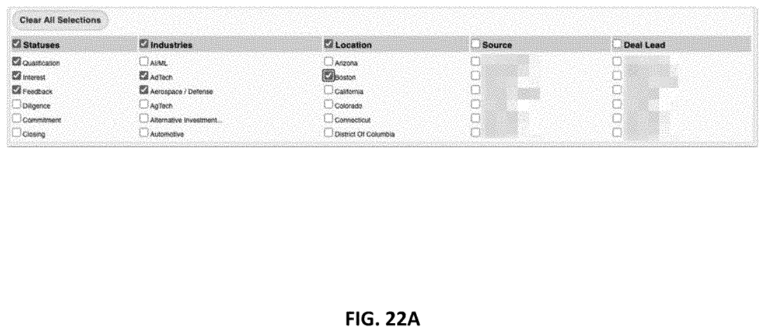

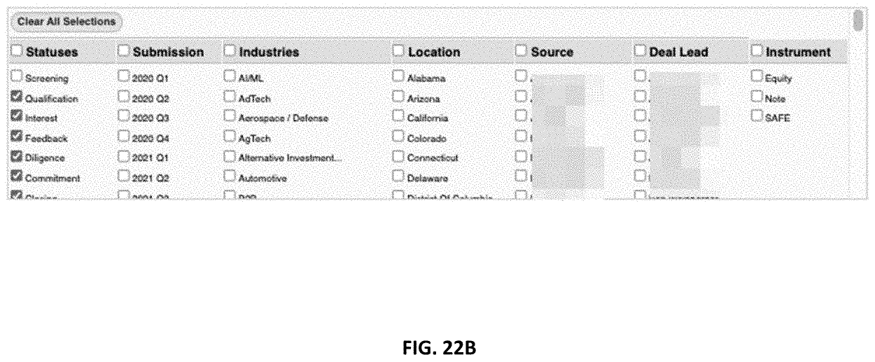

In some embodiments, the investment management system lists the deals available to the particular system user and includes features to allow for filtering the list to deals that meet certain criteria (e.g., exemplary user interfaces shown in FIG. 22A and FIG. 22B), such as company location, company industry, founder demographics, deal status.

The investment management system includes searching functionality to allow a system user to enter ad hoc text in effort to find matching deals available to the particular system user.

Analytics

The investment management system allows for the review of and provides analytics associated with users of or activity in the investment management system. These analytics may be specific to individual users or the compilation of users within an investment group or the compilation of users across multiple investment groups.

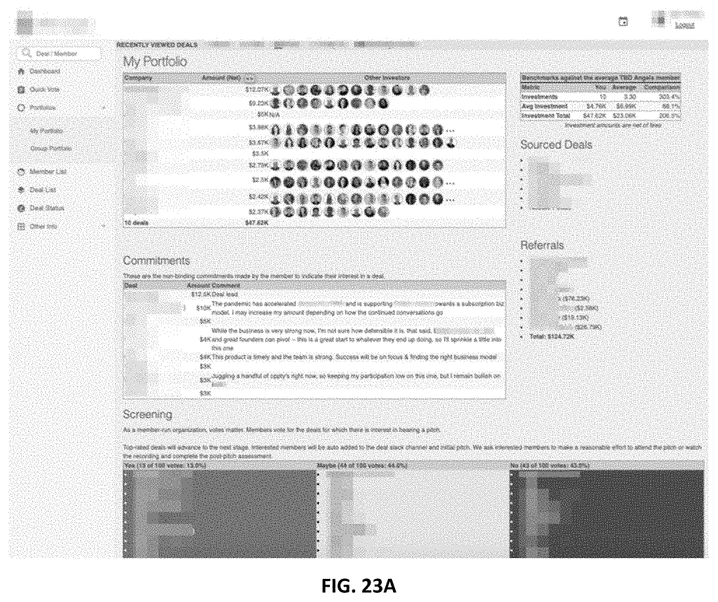

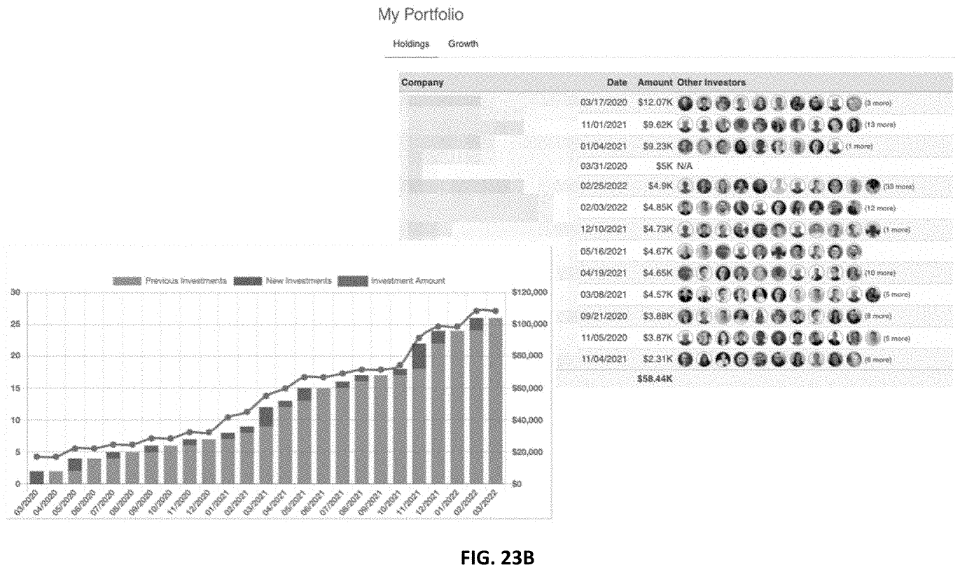

In some embodiments, the investment management system may include a portfolio of deals (e.g., exemplary user interfaces shown in FIG. 23A, FIG. 23B, FIG. 24A, and FIG. 24B) which may include performance metrics and other descriptive attributes related to individual deals or a portfolio of deals, such as dates of investment, investment amounts, participating investors, investment terms, company founder and team demographics.

In some embodiments, the investment management system may include performance statistics for an individual deal or a set of deals of deals which include current and time-series deal metrics including company valuation, investment gain/loss, percentage ownership.

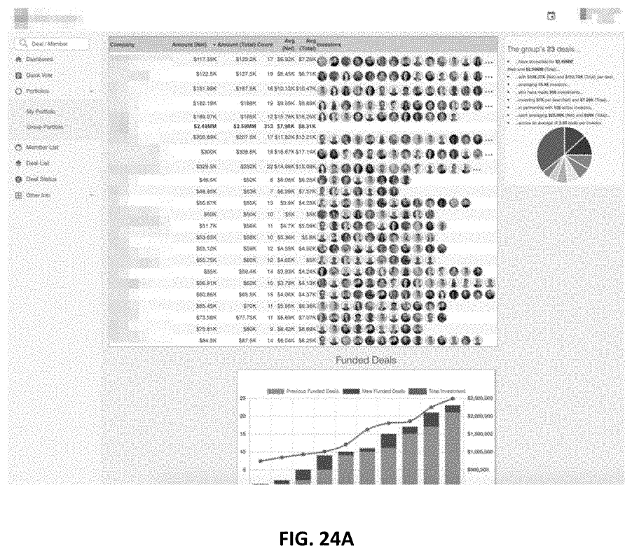

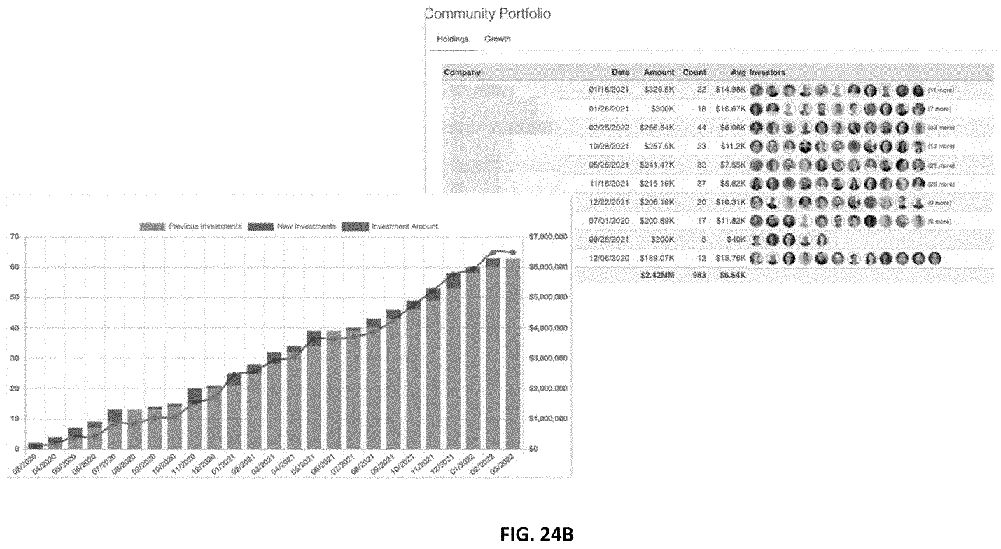

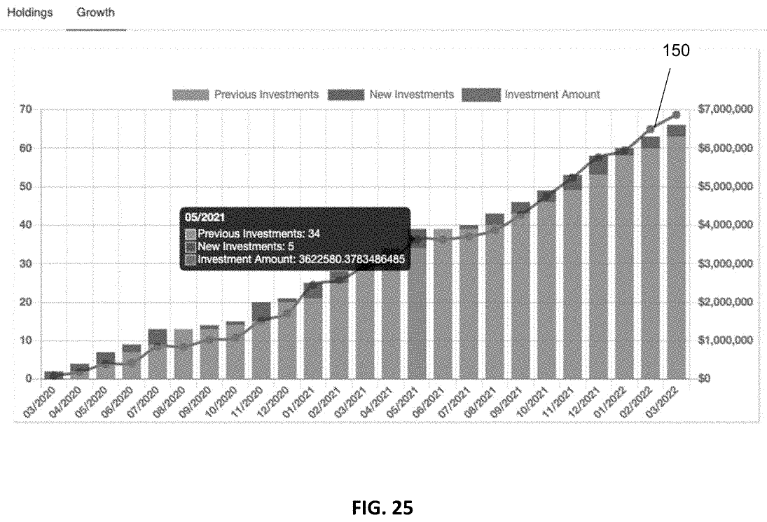

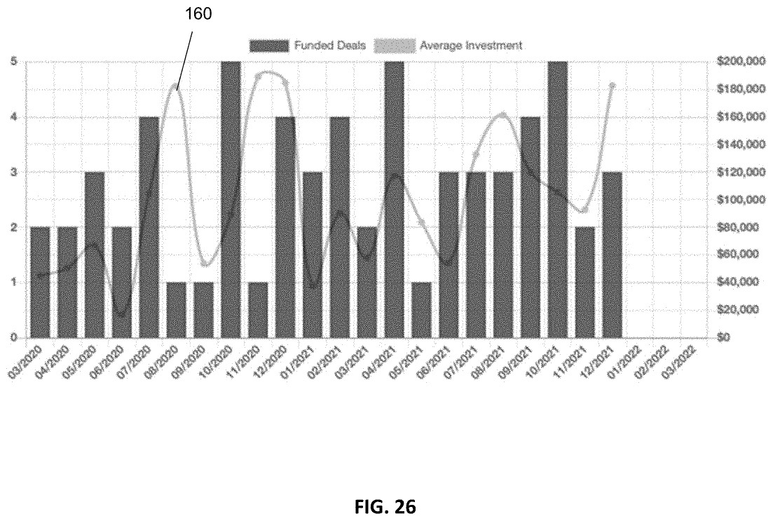

In some embodiments, the investment management system may include growth statistics over a period of time (e.g., an exemplary user interface shown in FIG. 25) and within individual time windows (e.g., month-over-month) (e.g., an exemplary user interface shown in FIG. 26). For example, FIG. 25 illustrates an exemplary user interface of a dynamically-generated graph of investment data over time, including information about previously-funded deals through the investment management system, newly-funded deals during each time period represented by the graph, and total investment (line 150) through the investment management system over time. FIG. 26 illustrates an exemplary user interface of a graph showing investments in the investment management system over time. The graph shown in FIG. 26 illustrates the number of funded deals in each time period represented in the graph, and the average investment over time (line 160).

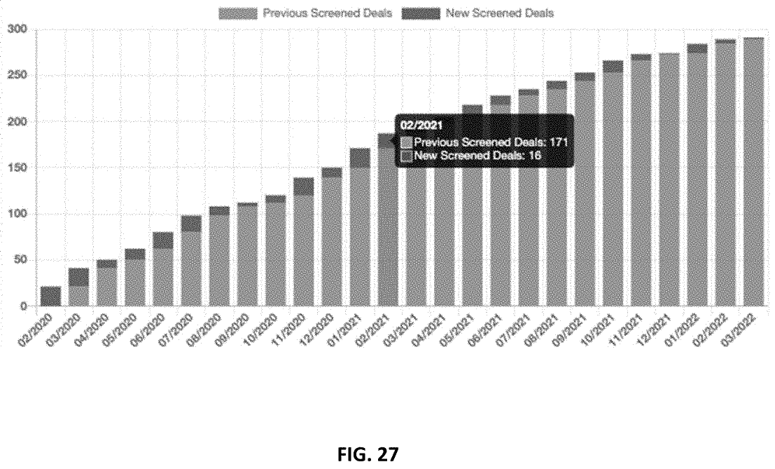

While the graphs shown in FIGS. 25 and 26 illustrates data regarding funded deals, graphs can also be generated relating to all or any subset of deals presented to the users of the system, including deals that are ultimately funded or unfunded over any relevant time period. In some embodiments, the investment management system may include metrics related to the deals reviewed over a period of time. For example, FIG. 27 illustrates an exemplary user interface of a graph showing information about the number of deals in the investment management system over time, including total number of deals and newly screened deals in each time period.

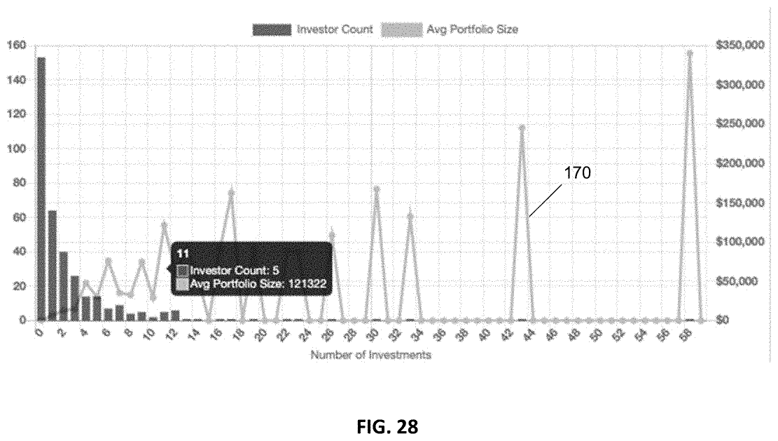

In some embodiments, the investment management system may include metrics related to the investment activity levels by investors within the investment group, as shown in an exemplary user interface shown in FIG. 28, including average portfolio size (line 170).

In some embodiments, the investment management system may include analytics between two or more deals to allow for comparison of various metrics including valuation, investment gain/loss, investor makeup.

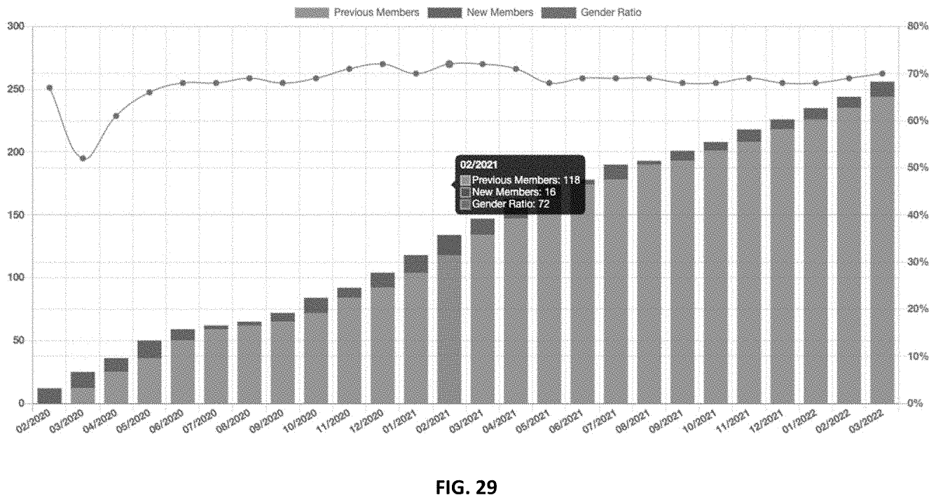

In some embodiments, the investment management system may include metrics related to the growth of an investment group size across a period of time. For example, FIG. 29 illustrates an exemplary user interface showing a graph of an investment group size over time. The analysis of the group size can include information relating to current members, previous members, and various demographic and/or industry information about the members. In some embodiments, the graph displayed to the users can include interactive features such that the user can hover over the graph and the user interface can display pop-up features with membership and demographic information.

In some embodiments, the investment management system may include metrics related to the activity associated with deals within the investment group, or deals acted on by an investor, or deals acted on by various investor cohorts. These activities may include deal screenings, deal commitments, deal investment categorized across one or more attributes which may include geography of deal company, industry of the deal company, demographics of the deal founder.

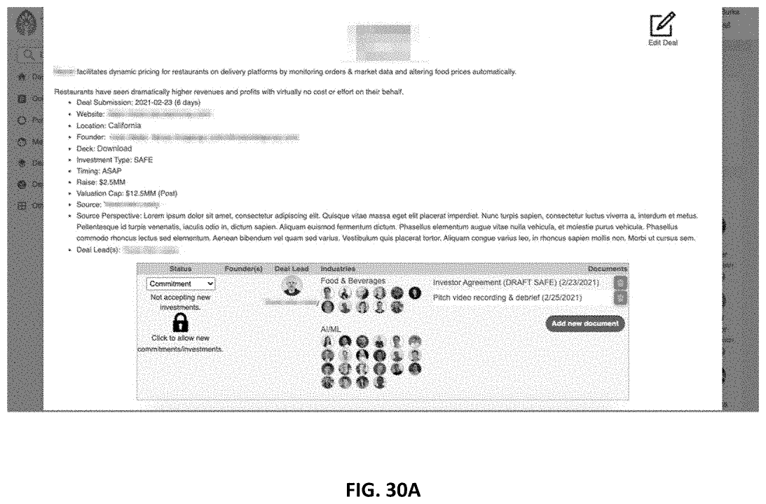

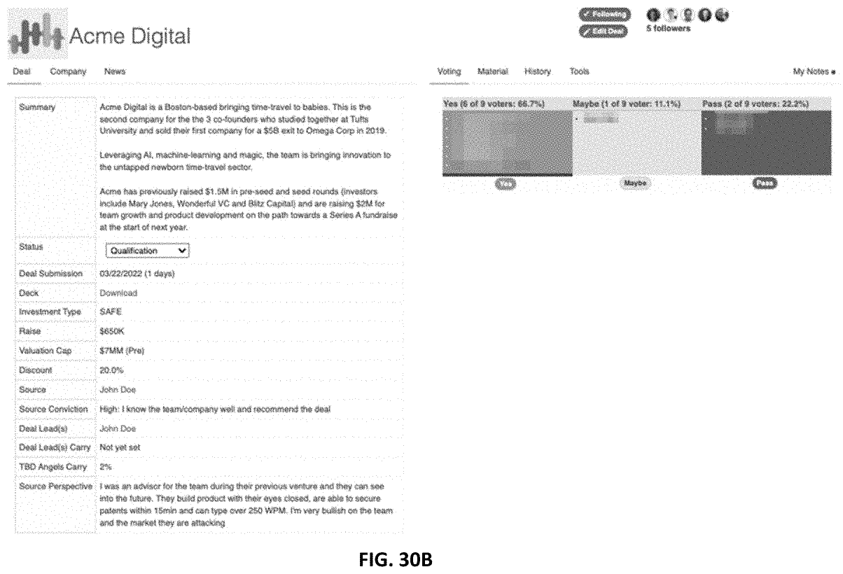

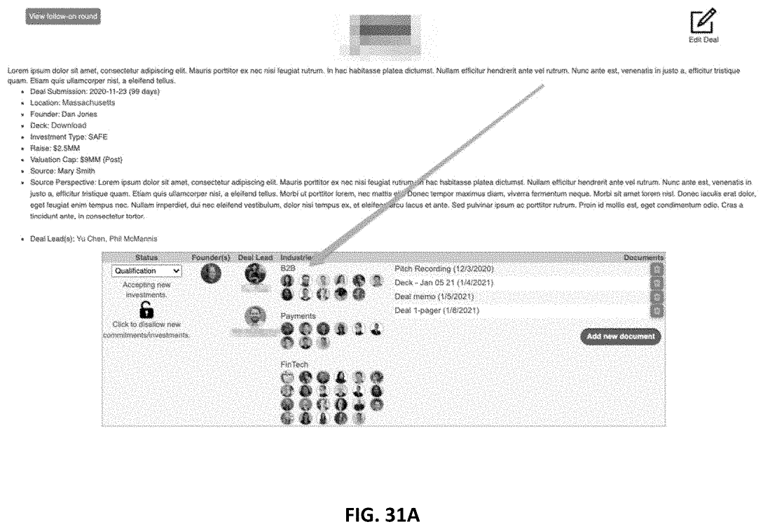

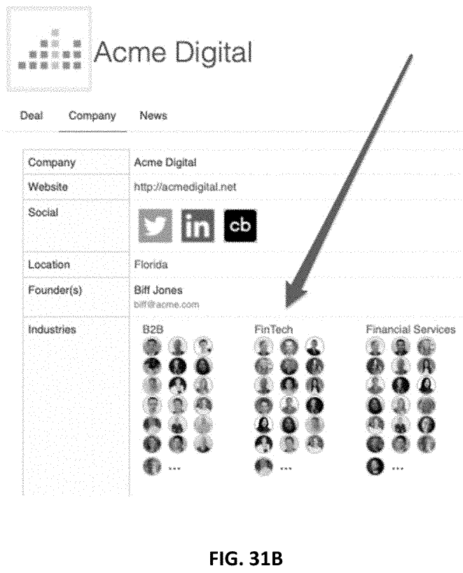

Deal analytics by a founder can include but is not limited to reviewing deal information (e.g., exemplary user interfaces shown in FIG. 30A and FIG. 30B), where the embodiment for deal information may have limited information viewable, or editable by the founder), reviewing the number of investors within an Investment Group who have experience in the same sectors as the deal company (e.g., exemplary user interfaces shown in FIG. 31A and FIG. 31B), reviewing interest levels in a deal, reviewing feedback for a deal, reviewing planned investment sum in a deal and, reviewing investment activity in a deal.

Investment Group Analytics by a Founder can include but is not limited to reviewing Investment Group's portfolio of investments (e.g., exemplary user interfaces shown in FIG. 24A and FIG. 24B), reviewing the Investment Group's investment counts and monetary levels over a period of time, and reviewing the investor makeup of the Investment group.

Investor Analytics by an Investor can include but is not limited to reviewing the Investor's portfolio of investments (e.g., exemplary user interfaces shown in FIG. 23A and FIG. 23B), reviewing an investor's interest levels in investment opportunities, reviewing an Investor's commitments to invest in deals, reviewing the investment levels of the Investors referred to a group by the investor, reviewing the investment amounts received by the companies referred to an investment group by the investor.

Investment Group Analytics by an investor can include but is not limited to reviewing Investment Group's portfolio of investments (e.g., exemplary user interfaces shown in FIG. 24A and FIG. 24B), reviewing the investment group's investment counts and monetary levels over a period of time, and reviewing the investor makeup of the Investment group across 1 or more attributes including demographics, industry experience, investment activity.

DEAL SHARING

The investment management system allows for investors and founders to expose a deal to other investors and to investment groups for purposes of deal management and analytics.

Deal Sharing by a founder can include but is not limited to exposing a deal owned by the founder, to one or more investors and to one or more investment groups. The invited parties will be able to engage in all, or a subset of the deal management functionality and all, or a subset of the deal analysis functionality.

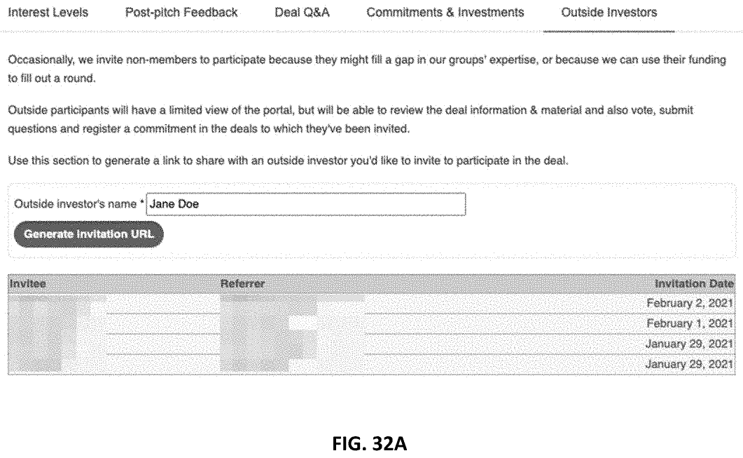

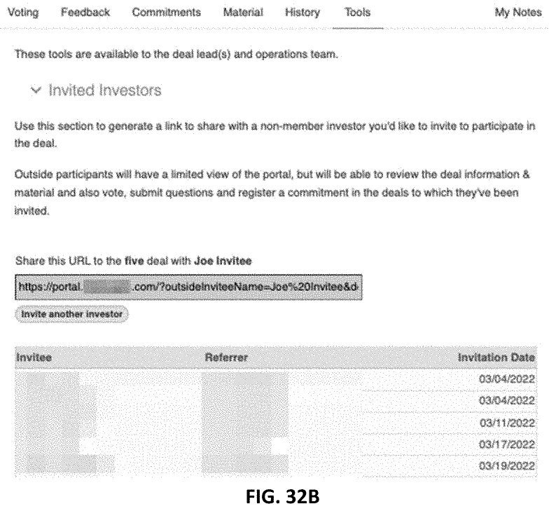

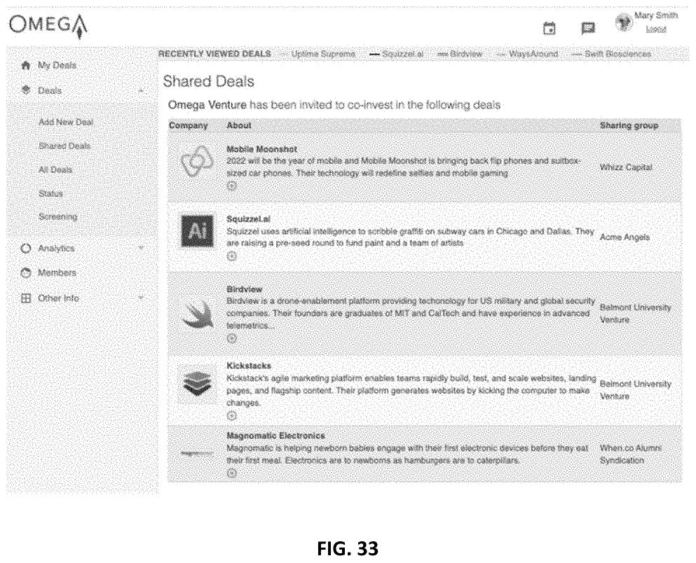

In some embodiments, Deal Sharing by an investor can include but is not limited to exposing a deal to one or more other investors (e.g., exemplary user interfaces shown in FIG. 32A and FIG. 32B) and one or more investment groups. The invited parties will be able to review deals to which they were invited (e.g., an exemplary user interface shown in FIG. 33), engage in all, or a subset of the deal management functionality and all, or a subset of the deal analysis functionality. This allows for communication between multiple investors or investor groups that are using the investment management system to run their own investments. For example, a first group using the investment management system can invite all or a subset of investors from a second group using the investment management system to allow for deal collaboration between groups for a variety of reasons, including allowing the members of the second group to vote on or commit to invest in a deal that has been presented to the first group. The first group can give permissions to the second groups to allow the second group to access information in the investment management system of the first group that is associated with that deal. It will be understood that any type of collaboration between groups can be allowed.

Deal Sharing Analytics by an Investment Group can include but is not limited to analytics of an individual deal, or analytics of multiple deals shared by or shared with an investment group.

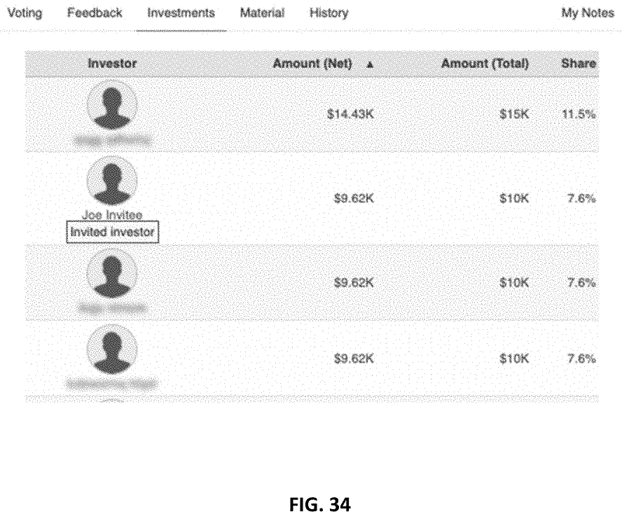

The investment management system can allow for the certain data, such as investor names, deal investments, to be suppressed from display to system users, such as investors, who have been invited to a particular deal, as shown, for example, in the exemplary user interface in FIG. 34.

Deal Sharing Analytics by a Group Administrator can include, but is not limited to, analytics of an individual deal or analytics of multiple deals within an investment group or across multiple investment groups.

Users

The investment management system can also include features to allow for following interaction of system users. In some embodiments, the investment management system allows for investors and/or investment groups to select one or more other investors and/or founders whose system activity should be highlighted within their instance of the investment management system. For example, the system can allow a user, such as an investor, to dynamically receive information relating to the activity of one or more other users of the system. For example, when the user of interest interacts with the system, such as voting on a deal, the system can alert or notify other users of this activity. This can allow users to track the activity of other system users. In some embodiments, the system can allow a user to select one or more other users to follow and can allow the user to select the type of information about that user that they want to be notified of.

In some embodiments, Investor Following can include but is not limited to an Investor identifying other investors whose deal activity and deal investments will be surfaced to Investor for analysis. This allows an investor or investor groups to track and/or follow the activity of one or more other investors or investor groups using the investment management system. For example, information relating to deals which received votes, deals on which investment commitments were made, deals viewed, or deals declined can be analyzed.

Founder Following can include but is not limited to an Investor identifying founders whose deals they wish to review.

Founder Following can include but is not limited to an Investment Group identifying founders whose deals should be highlighted to Investors within that Investment Group.

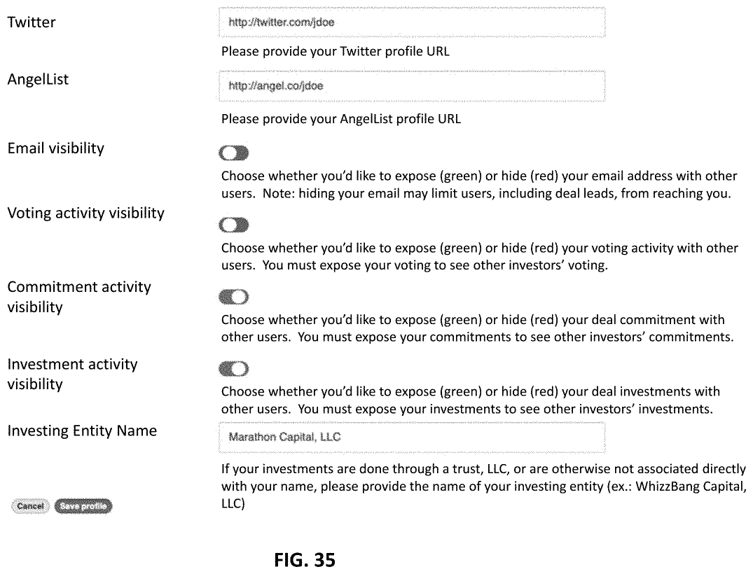

The investment management system allows Investors to register an account which can be associated with 0 or more Investment Groups. The Investor registration can include the configuration of various attributes including headshot, contact information, Investor expertise, investment preferences, business rules (e.g., an exemplary user interface shown in FIG. 35).

The investment management system allows Invited Investors to register an account which can be associated with 1 or more deals. The Invited Investor registration can include the configuration of various attributes including headshot, contact information, Investor expertise, investment preferences.

The investment management system allows founders to register an account with the investment management system which can be associated with one or more companies and the deals associated with those companies. The founder registration can include the configuration of various attributes including headshot, contact information, demographic information.

The investment management system lists the users, including investors and founders, that are associated with the system access for the current users. The user listing includes features to allow for filtering the list to users that meet certain criterial, such as user location, investment activity, demographics, industries and expertise.

In some embodiments, the user listing may allow a system user to access the email addresses, or other contact information of users available in the list.

The investment management system includes searching functionality to allow a system user to enter ad hoc text in effort to find matching investors and founders which are associated with the system access for the current user.

Recommendations

The investment management system allows for the surfacing of Investors and Founders to users based on various factors, such as similarity of system activity, alignment in career industries, or exhibiting attributes of interest to that user (e.g., female founders, active investors).

Investor Recommendation to Founders can include, but is not limited to, surfacing Investors whose career industries align with those industries of the Founder's deal, Investors whose declared investment interests (e.g., deals with a founder of a certain demographic and/or deals with first-time founders) align with the attributes of the Founder's deal, the deals invested in by the investor which exhibit similarity to the Founder's deal.

Investment Group Recommendation to Founders can include, but is not limited to surfacing Investment Groups where the career industries of the Group's member Investors align with those industries of the Founder's deal, Investment Groups where the declared investment interests of the Group's member Investors (e.g., deals with a founder of a certain demographic, deals with first-time founders) align with the attributes of the Founder's deal, the deals invested by the Investment Group which exhibit similarity to the Founder's deal.

Deal Recommendation to Investors can include but is not limited to surfacing deals that align with the Investor's areas of expertise, align with the Investor's career industries, align with the Investor's declared investment interests (e.g., deals with a founder of a certain demographic, deals with first-time founders), and/or the deals invested in by other investors which exhibit similarity to the Investor. This allows the investment management system to provide analysis of information provided to the investment management system by the investors, information relating to activity the investor has participated in relating to investments and deal, and/or information relating to other similar investors to make deal recommendations to the investors. Deal recommendations can be communicated to the investor in a variety of ways, including messaging in or through the investment management system, an email, or other communication modality. In some embodiments, the investment management system can also include the response of the investor to past deal recommendations to increase the accuracy of the deal recommendation analysis.

Deal recommendation to investment groups can include, but is not limited to, surfacing deals that align with the areas of expertise of the group's member investors, align with the career industries of the group's member investors, align with the declared investment interests of the group's member investors (e.g., deals with a founder of a certain demographic, deals with first-time founders), the deals invested in by other investment groups which exhibit similarity to the investment group.

Investment Group Recommendation to Investors can include, but is not limited to surfacing Investment Groups where the career industries of the Group's member Investors align with those industries of the Investor, Investment Groups where the declared investment interests of the Group's member Investors (e.g., deals with a founder of a certain demographic, deals with first-time founders) align with the investment interests of the Investor, the deals invested by the Investment Group exhibit similarity to the deals invested in by the Investor.

In some embodiments, the investment management system can also allow investors or investor groups to make recommendations of Investors and Investment Groups to other Investment Groups and to Founders. Investor Recommendation to Investors can include, but is not limited to, surfacing Investors whose career industries align with those industries of the Investor, Investors whose declared investment interests (e.g., deals with a founder of a certain demographic, deals with first-time founders) align with the investment interests of the Investor, the deals invested by the investor which exhibit similarity to deals invested in by the Investor.

External System Integrations

In some embodiments, the investment management system can be in communication with external systems that can provide support and/or work in conjunction with one or more features of the investment management system. External System integration can include but is not limited to sending data from the investment management system to an External System, receiving data from an External System into the investment management system, and enabling functionality from an External System in the investment management system.

In some embodiments, the investment management system allows for the user to authenticate with the External System using the user's own credentials with the External System.

In some embodiments, the investment management system authenticates with the External System using its own credentials with the External System.

In some embodiments, the investment management system may send data associated with a deal and one or more investors' commitments to an External System.

In some embodiments, the investment management system may receive data associated with a deal and one or more investors' investments from an External System.

In some embodiments, the investment management system may receive data associated with a deal and one or more investors' funding statuses from an External System.

In some embodiments, the investment management system may have features to compare, reconcile and provide analytics associated with one or more deal commitments within the investment management systems and investments within an External System.

In some embodiments, the investment management system may send data to, or receive data from an External System using APIs, file protocols, or email.

Communication

The investment management system can allow a Founder to communicate with Investors or Investor Groups.

In some embodiments, the investment management system can allow a founder to communicate with other system users, such as investors or investor groups, such that the founder can, for example, submit answers to questions about their deal. For example, as shown in FIG. 10, a founder can be presented with an interface that lists requests for information from other system users, such as a list of questions and/or requests for documentation. The investment management system can allow the founder to enter answers that will be communicated to one or more investors or investor groups that are associated with the deal. It will be understood that founder communication can be with any of the investors or investors groups associated with the investment management system, regardless of the investor or investor groups interest in or association with a deal. In some embodiments, a founder can review levels of interest in their deal and/or can review planned investments in their deal.

System Management

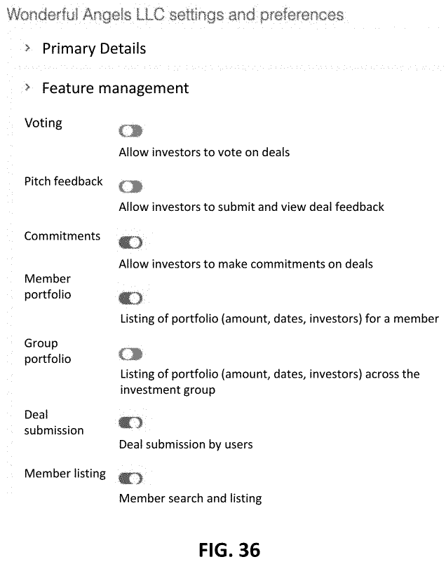

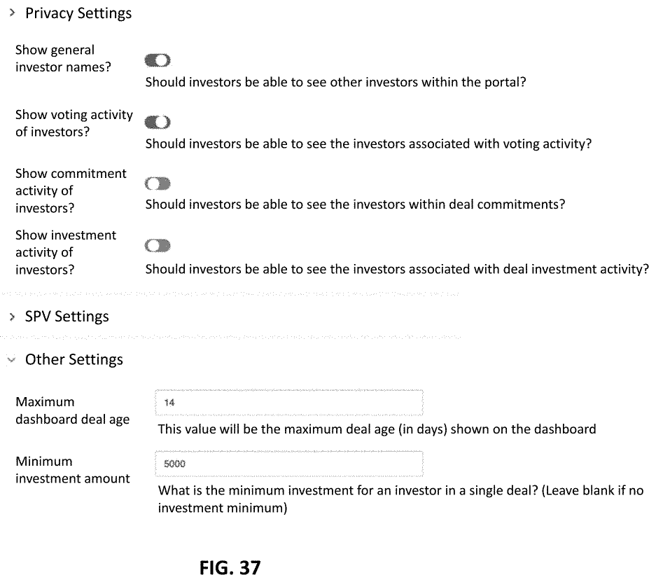

System management by a Group Administrator can include but is not limited to provisioning system access to Investors for their Investment Group, configuring data access rights and other business rules (e.g., exemplary user interfaces shown in FIG. 36 and FIG. 37) for the Investors and Founders who have been invited to access their Investment Group.

System access management by a Founder can include but is not limited to inviting deal company employees to the investment management system for deal management and inviting deal company employees to the investment management system for answering investor questions.

The investment management system can also allow an investor to view information related to a deal associated with the investor as shown in FIG. 30A and FIG. 30B and allow the investor to view collateral associated with such deals as shown in FIG. 5.

System access management by an Investor can include but is not limited to inviting deal company founders to the investment management system for deal management (e.g., an exemplary user interface shown in FIG. 19), inviting deal company employees to the investment management system for answering investor questions, inviting Investors from outside the Investment Group (e.g., exemplary user interfaces shown in FIG. 32A and FIG. 32B) to the investment management system for the analysis and management of individual deals.

It will be understood that any functionality in the investment management system available to an investor can also be used by an investor group.

The investment management system can also allow a System Administrator to configure the features available to an investment group. In some embodiments, the investment management system can also allow a Group Administrator to configure business settings, such as minimum deal investment amounts, the various data fields that should not be shown to users associated with the particular group. In some embodiments, the investment management system can also allow an investor to configure settings associated with the investor information and activity, such as configuring the visibility of the investor's email address, or of the investor's investment activity to other users of the system. In some embodiments, the investment management system can also allow a founder to configure business settings associated with the founder's deals, such as the visibility of certain company information, or permissions associated with deal information (e.g., ability to download material).

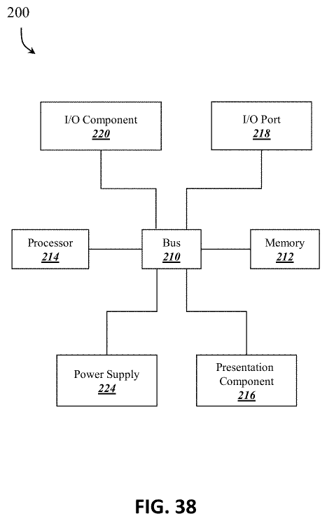

Any suitable computing device can be used to implement the computing devices and methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 200 is depicted in FIG. 38. The computing device 200 is merely an illustrative example of a suitable computing environment and in no way limits the scope of the present invention. A “computing device,” as represented by FIG. 38, can include a “workstation,” a “server,” a “laptop,” a “desktop,” a “hand-held device,” a “mobile device,” a “tablet computer,” or other computing devices, as would be understood by those of skill in the art. Given that the computing device 200 is depicted for illustrative purposes, embodiments of the present invention may utilize any number of computing devices 200 in any number of different ways to implement a single embodiment of the present invention. Accordingly, embodiments of the present invention are not limited to a single computing device 200, as would be appreciated by one with skill in the art, nor are they limited to a single type of implementation or configuration of the example computing device 200.

The computing device 200 can include a bus 210 that can be coupled to one or more of the following illustrative components, directly or indirectly: a memory 212, one or more processors 214, one or more presentation components 216, input/output ports 218, input/output components 220, and a power supply 224, One of skill in the art will appreciate that, the bus 210 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 38 is merely illustrative of an exemplary computing device that can be used to implement one or more embodiments of the present invention, and in no way limits the invention.

The computing device 200 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 200.

The memory 212 can include computer-storage media in the form of volatile and/or nonvolatile memory. The memory 212 may be removable, non-removable, or any combination thereof. Exemplary hardware devices are devices such as hard drives, solid-state memory, optical-disc drives, and the like. The computing device 200 can include one or more processors that read data from components such as the memory 212, the various I/O components 216, etc. Presentation component(s) 216 present data indications to a user or other device. Exemplary presentation components include a display device, speaker, printing component, vibrating component, etc.

The I/O ports 218 can enable the computing device 200 to be logically coupled to other devices, such as I/O components 220. Some of the I/O components 220 can be built into the computing device 100. Examples of such I/O components 220 include a microphone, joystick, recording device, game pad, satellite dish, scanner, printer, wireless device, networking device, and the like.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will he appreciated that embodiments may be variously combined or separated without parting from the invention. It is intended that the present invention be limited only to the extent required by the appended claims and the applicable rules of law.

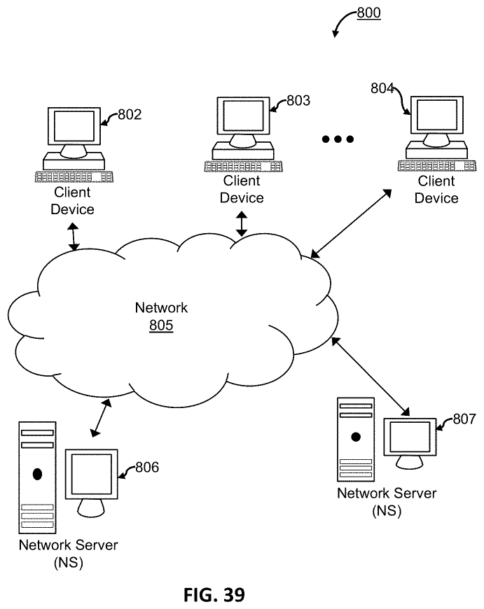

FIG. 39 depicts a block diagram of an exemplary computer-based system and platform 800 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 800 may be configured to manage a large number of members and concurrent transactions, as detailed herein. In some embodiments, the exemplary computer-based system and platform 800 may be based on a scalable computer and network architecture that incorporates various strategies for assessing the data, caching, searching, and/or database connection pooling. An example of the scalable architecture is an architecture that is capable of operating multiple servers.

In some embodiments, referring to FIG. 39, member computing device 802, member computing device 803 through member computing device 804 (e.g., clients) of the exemplary computer-based system and platform 800 may include virtually any computing device capable of receiving and sending a message over a network (e.g., cloud network), such as network 805, to and from another computing device, such as servers 806 and 807, each other, and the like. In some embodiments, the member devices 802-804 may be personal computers, multiprocessor systems, microprocessor-based or programmable consumer electronics, network PCs, and the like. In some embodiments, one or more member devices within member devices 802-804 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 802-804 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 802-804 may include may run one or more applications, such as Internet browsers, mobile applications, voice calls, video games, videoconferencing, and email, among others. In some embodiments, one or more member devices within member devices 802-804 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language; (WML), WMLScript, XML, JavaScript, and the like. In some embodiments, a member device within member devices 802-804 may be specifically programmed by either Java, .Net, QT, C, C++ and/or other suitable programming language. In some embodiments, one or more member devices within member devices 802-804 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 805 may provide network access, data transport and/or other services to any computing device coupled to it. In some embodiments, the exemplary network 805 may include and implement at least one specialized network architecture that may be based at least in part on one or more standards set by, for example, without limitation, Global System for Mobile communication (GSM) Association, the Internet Engineering Task Force (LETO, and the Worldwide Interoperability for Microwave Access (WiMAX) forum. In some embodiments, the exemplary network 805 may implement one or more of a GSM architecture, a General Packet Radio Service (GPRS) architecture, a Universal Mobile Telecommunications System (UNITS) architecture, and an evolution of UMTS referred to as Long Term Evolution (LTE). In some embodiments, the exemplary network 805 may include and implement, as an alternative or in conjunction with one or more of the above, a WiMAX architecture defined by the WiMAX forum. In some embodiments and, optionally, in combination of any embodiment described above or below, the exemplary network 805 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 805 may be transmitted based at least in part on one of more communication modes such as but not limited to: NFC, RFID, Narrow Band Internet of Things (NBIOT), ZigBee, 3G, 4G, 5G, GSM, GPRS, WiMax, CDMA, satellite and any combination thereof. In some embodiments, the exemplary network 805 may also include mass storage, such as network attached storage (NAS), a storage area network (SAN), a content delivery network (CDN) or other forms of computer or machine readable media.

In some embodiments, the exemplary server 806 or the exemplary server 807 may be a web server (or a series of servers) running a network operating system, examples of which may include but are not limited to Microsoft Windows Server, Novell NetWare, or Linux. In some embodiments, the exemplary server 806 or the exemplary server 807 may be used for and/or provide cloud and/or network computing. Although not shown in FIG. 39, in sonic embodiments, the exemplary server 806 or the exemplary server 807 may have connections to external systems like email, SMS messaging, text messaging, ad content providers, etc. Any of the features of the exemplary server 806 may be also implemented in the exemplary server 807 and vice versa.

In some embodiments, one or more of the exemplary servers 806 and 807 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 801-804.

In some embodiments and, optionally, in combination of any embodiment described above or below, for example, one or more exemplary computing member devices 802-804, the exemplary server 806, and/or the exemplary server 807 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

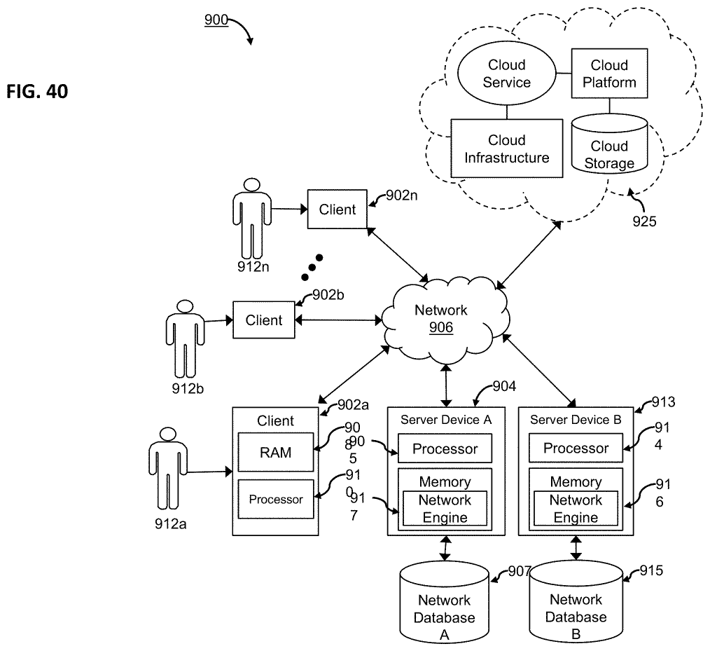

FIG. 40 depicts a block diagram of another exemplary computer-based system and platform 900 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 902a, member computing device 902b through member computing device 902n shown each at least includes a computer-readable medium, such as a random-access memory (RAM) 908 coupled to a processor 910 or FLASH memory. In some embodiments, the processor 910 may execute computer-executable program instructions stored in memory 908. In some embodiments, the processor 910 may include a microprocessor, an ASIC, and/or a state machine. In some embodiments, the processor 910 may include, or may be in communication with, media, for example computer-readable media, which stores instructions that, when executed by the processor 910, may cause the processor 910 to perform one or more steps described herein. In some embodiments, examples of computer-readable media may include, but are not limited to, an electronic, optical, magnetic, or other storage or transmission device capable of providing a processor, such as the processor 910 of client 902a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 902a through 902n may also comprise a number of external or internal devices such as a mouse, a CD-ROM, DVD, a physical or virtual keyboard, a display, or other input or output devices. In some embodiments, examples of member computing devices 902a through 902n (e.g., clients) may be any type of processor-based platforms that are connected to a network 906 such as, without limitation, personal computers, digital assistants, personal digital assistants, smart phones, pagers, digital tablets, laptop computers, Internet appliances, and other processor-based devices. In some embodiments, member computing devices 902a through 902n may be specifically programmed with one or more application programs in accordance with one or more principles/methodologies detailed herein. In some embodiments, member computing devices 902a through 902n may operate on any operating system capable of supporting a browser or browser-enabled application, such as Microsoft™, Windows™, and/or Linux. In some embodiments, member computing devices 902a through 902n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 902a through 902n, user 912a, user 912b through user 912n, may communicate over the exemplary network 906 with each other and/or with other systems and/or devices coupled to the network 906. As shown in FIG. 40, exemplary server devices 904 and 913 may include processor 905 and processor 914, respectively, as well as memory 917 and memory 916, respectively. In some embodiments, the server devices 904 and 913 may be also coupled to the network 906. In some embodiments, one or more member computing devices 902a through 902n may be mobile clients.

In some embodiments, at least one database of exemplary databases 907 and 915 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, My SQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

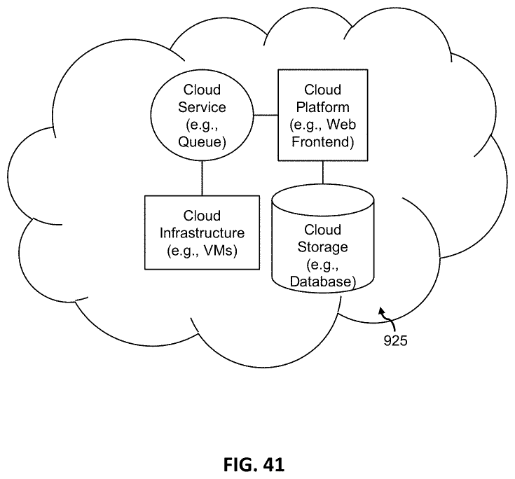

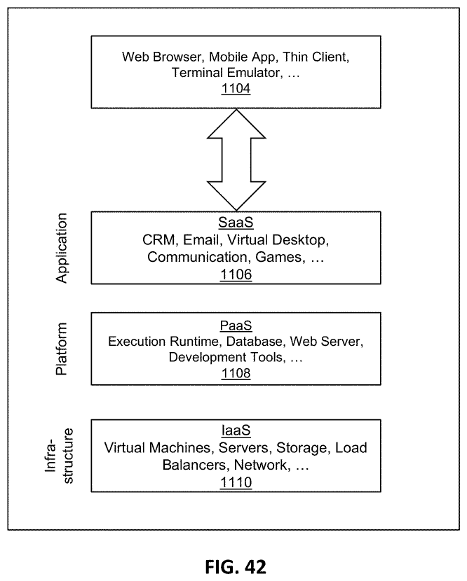

In some embodiments, the exemplary inventive computer-based systems/platforms, the exemplary' inventive computer-based devices, and/or the exemplary inventive computer-based components of the present disclosure may be specifically configured to operate in a cloud computing/architecture 925 such as, but not limiting to: infrastructure a service (IaaS) 1110, platform as a service (PaaS) 1108, and/or software as a service (SaaS) 1106 using a web browser, mobile app, thin client, terminal emulator or other endpoint 1104. FIGS. 41 and 42 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

In some embodiments, the pathology information of a patient can be compared to personal history of the same patient to see a progression (regression). The progression (regression) of the patient can also be compared to other population cohorts and their historical progression (regression).

The server can implement the machine learning algorithm by way of one or more neural networks. The machine learning algorithm can include logistic regression, variational autoencoding, convolutional neural networks, or other statistical techniques used to identify and discern neurogenerative disease-associated pathologies. The machine learning algorithm can also use spectral scattering models, other scattering models, or optical physics models that are validated a priori. The neural network may comprise a plurality of layers, some of which are defined and some of which are undefined (or hidden). The neural network is a supervised learning neural network.

In some examples, the neural network may include a neural network input layer, one or more neural network middle hidden layers, and a neural network output layer. Each of the neural network layers include a plurality of nodes (or neurons). The nodes of the neural network layers are connected, typically in series. The output of each node in a given neural network layer is connected to the input of one or more nodes in a subsequent neural network layer. Each node is a logical programming unit that performs an activation function (also known as a transfer function) for transforming or manipulating data based on its inputs, a weight (if any) and bias factor(s) (if any) to generate an output. The activation function of each node results in a particular output in response to particular input(s), weight(s) and bias factor(s). The inputs of each node may be scalar, vectors, matrices, objects, data structures and/or other items or references thereto. Each node may store its respective activation function, weight (if any) and bias factors (if any) independent of other nodes. In some example embodiments, the decision of one or more output nodes of the neural network output layer can be calculated or determined using a scoring function and/or decision tree function, using the previously determined weight and bias factors, as is understood in the art.

In some examples, the classification (output of the second neural network) can be one or more conclusions as to whether the subject has a neurogenerative pathology, or a precursor to a neurogenerative pathology, or is pre-screened for potential of neurogenerative pathology and requires further investigation. Such neurogenerative pathology conclusions can be based on one or a plurality of pathologies that are classified by the neural network, and determined or calculated using e.g., a combined weighted score, scorecard, or probabilistic determination. For example, the presence or probabilistic classification of both Amyloid Beta and Tau neurofibrillary tangles may lead to a higher probability conclusion of a neurogenerative pathology. In some examples, the conclusions can also be based on the changes over time of the patient physiology, for example by comparing with previous spectroscopy information of the patient. In some examples, the hyperspectral reflectance information is also used as input information to the neural network, which further assists in classifying neurogenerative pathologies.

From the foregoing description, it will be apparent that variations and modifications may be made to the embodiments of the present disclosure to adopt it to various usages and conditions. Such embodiments are also within the scope of the following claims.

The recitation of a listing of elements in any definition of a variable herein includes definitions of that variable as any single element or combination (or sub-combination) of listed elements. The recitation of an embodiment herein includes that embodiment as any single embodiment or in combination with any other embodiments or portions thereof.

1. A system for managing investments, comprising:
at least one processor configured to:
receive a selection from one or more users relating to interest from the one or more users in an investment opportunity, wherein interest is in the form of a vote;
determine if an aggregate of the selections from the one or more users relating to the interest in the investment opportunity reaches a threshold amount of interest;
present if the threshold amount of interest has been met, information relating to the investment opportunity; and
receive a selection from the one or more users relating to a financial commitment from the one or more users in the investment opportunity.

2. The system of claim 1, wherein the at least one processor is configured to store a status of the investment opportunity, and the status of the investment opportunity is dynamically updated by the processor if the threshold amount of financial commitment is met.

3. The system of claim 1, wherein the at least one processor is configured to store a status of the investment opportunity, and the status of the investment opportunity is dynamically updated by the processor if the threshold amount of interest is met.

4. The system of claim 1, wherein the at least one processor is configured to store a status of the investment opportunity, the status of the investment opportunity including a deal screening stage in which the one or more users make selections regarding interest in the deal and a deal finance stage in which the threshold amount of money is met.

5. The system of claim 1, wherein the at least one processor is further configured to communicate with an external financial platform, information relating to a total of the financial commitments from each user and a list of users associated with the financial commitments.

6. The system of claim 1, wherein the at least one processor is further configured to display interest in an investment opportunity including at least one of a list of users having indicated a certain level of interest in the investment opportunity and metrics associated with the interest in the investment opportunity.

7. A method for managing investments, comprising:
receiving, by at least one processor, a selection from one or more users relating to interest from the one or more users in an investment opportunity, wherein interest is in the form of a vote;
determining, by the at least one processor, if an aggregate of the selections from the one or more users relating to the interest in the investment opportunity reaches a threshold amount of interest;
presenting, by at least one processor, if the threshold amount of interest has been met, information relating to the investment opportunity; and
receiving, by at least one processor, a selection from the one or more users relating to a financial commitment from the one or more users in the investment opportunity.

8. The method of claim 7, further comprising determining, by the at least one processor, if an aggregate of the selections from the one or more users relating to the financial commitments in the investment opportunity reaches a threshold amount of money.

9. The method of claim 7, wherein a status of the investment opportunity is updated if the threshold amount of financial commitment is met.

10. The method of claim 7, wherein a status of the investment opportunity is updated if the threshold amount of interest is met.

11. The method of claim 9, wherein the status of the deal includes a deal screening stage in which the one or more users make selections regarding interest in the deal and a deal finance stage in which the threshold amount of money is met.

12. The method of claim 7, further comprising communicating, by the at least one processor, to an external financial platform, information relating to a total of the financial commitments from each user and a list of users associated with the financial commitments.

13. The method of claim 7, further comprising displaying, by the at least one processor, interest in an investment opportunity including at least one of a list of users having indicated a certain level of interest in the investment opportunity and metrics associated with the interest in the investment opportunity.

14. A method for managing investments, comprising:
presenting, by at least one processor, information relating to an investment opportunity to one or more users;
receiving, by at least one processor, a selection from the one or more users relating to a financial commitment from the one or more users in the investment opportunity;
determining, by the at least one processor, if an aggregate of the selections from the one or more users relating to the financial commitment in the investment opportunity reaches a threshold amount of money; and
updating, by at least one processor, if the threshold amount of financial commitment has been met, a status of the investment opportunity to indicate that the investment opportunity is funded.

15. The method of claim 14, further comprising receiving, by at the least one processor, a selection from one or more of the users relating to interest from the one or more users in the investment opportunity.

16. The method of claim 14, further comprising communicating, by the at least one processor, to an external financial platform, information relating to a total of the financial commitments from each user and a list of users associated with the financial commitments.
